(19) United States
(12) Patent Application Publication
(10) Pub. No.: US 2013/0167932 A1
(43) Pub. Date: Jul. 4, 2013

(54) INDOLE COMPOUND, AND PHOTOELECTRIC CONVERSION DYE USING SAME, SEMICONDUCTOR ELECTRODE, PHOTOELECTRIC CONVERSION ELEMENT, AND PHOTOELECTROCHEMICAL CELL

(71) Applicants: Katsumi Maeda, Tokyo (JP); Shin Nakamura, Tokyo (JP); Kentaro Nakahara, Tokyo (JP); Terumasa Shimoyama, Tokyo (JP)

(72) Inventors: Katsumi Maeda, Tokyo (JP); Shin Nakamura, Tokyo (JP); Kentaro Nakahara, Tokyo (JP); Terumasa Shimoyama, Tokyo (JP)

(73) Assignee: NEC CORPORATION, Tokyo (JP)

(21) Appl. No.: 13/822,577

(22) PCT Filed: Nov. 7, 2011
(86) PCT No.: PCT/JP2011/075532

§ 371 Date: Mar. 12, 2013

(30) Foreign Application Priority Data
Nov. 8, 2010 (JP) 2010-249744
Sep. 22, 2011 (JP) 2011-207708

(51) Int. Cl. C09B 57/00; H01G 9/20

(52) U.S. Cl. CPC C09B 57/00; H01G 9/2059
USPC 136/263; 548/466; 548/454; 252/501.1

(57) ABSTRACT

Provided is an indole compound represented by the following general formula (1):

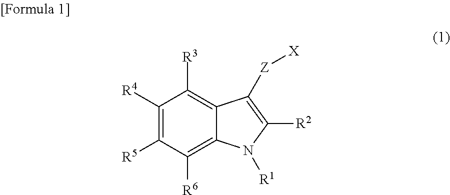

wherein in formula (1), R¹ and R² each independently represent a hydrogen atom, a substituted or unsubstituted alkyl group, a substituted or unsubstituted aryl group or a substituted or unsubstituted heterocyclic group; R³ to R⁶ each independently represent a hydrogen atom, a substituted or unsubstituted alkyl group, a substituted or unsubstituted aryl group, an alkoxy group or a hydroxy group; X represents an organic group having an acidic group; and Z represents a linking group including at least one selected from the group consisting of a substituted or unsubstituted aromatic ring, a substituted or unsubstituted heterocyclic ring, a vinylene group and an ethynylene group.

### TECHNICAL FIELD

The present invention relates to an indole compound, and a photoelectric conversion dye using the indole compound, a semiconductor electrode, a photoelectric conversion element and a photoelectrochemical cell.

### BACKGROUND ART

The past mass consumption of fossil fuels typified by petroleum has caused serious problem of the global warming due to the increase of the CO₂ concentration, and further the depletion of fossil fuels is apprehended. Accordingly, the way of covering the future demand of a huge amount of energy offers a significant challenge on a global basis. Under such circumstances, the use of light energy, infinite and clean in contrast to nuclear power generation, for generating electricity has been actively investigated. As solar cells converting light energy into electric energy, there have been proposed inorganic solar cells using inorganic materials such as single crystal silicon, polycrystalline silicon and amorphous silicon and organic solar cells using organic dyes or conductive polymer materials.

The dye-sensitized solar cell (Graetzel-type solar cell) (Non Patent Literature 1 and Patent Literature 1) proposed by Dr. Graetzel and others in Switzerland in 1991 can be produced by a simple production process, and such conversion efficiency that is comparable with the conversion efficiency attained with amorphous silicon can be obtained, and hence the cell is expected to be a next-generation solar cell under such circumstances. The Graetzel-type solar cell includes a semiconductor electrode in which a semiconductor layer adsorbing a dye is formed on a conductive substrate, a counter electrode made of a conductive substrate, facing the semiconductor electrode, and an electrolyte layer held between both electrodes.

In the Graetzel-type solar cell, the adsorbed dye absorbs light to be excited to an excited state, and an electron is injected from the excited dye into the semiconductor layer. The dye made to be in an oxidized state by electron ejection gets back to the original dye, by the electron transfer to the dye due to the oxidation reaction of the redox agent in the electrolyte layer. The redox agent donating an electron to the dye is again reduced on the counter electrode side. Through such a series of reactions, the Graetzel-type solar cell functions as a cell.

The Graetzel-type solar cell has an outstanding feature such that the use of porous titanium oxide made of sintered fine particles as the semiconductor layer increases the effective reaction surface area by a factor of as large as about 1000, and thus a larger photocurrent can be taken out.

In the Graetzel-type solar cell, metal complexes such as ruthenium complexes are used as the sensitizing dye; specific examples of the ruthenium complexes used in the Graetzel-type solar cell include: bipyridine complexes of ruthenium such as cis-bis(isothiocyanato)-bis-(2,2′-bipyridyl-4,4′-dicarboxylato)ruthenium (II) di-tetrabutylammonium complex and cis-bis(isothiocyanato)-bis-(2,2′-bipyridyl-4,4′-dicarboxylato)ruthenium (II); and tris(isothiocyanato)(2,2′:6′,2″-terpyridyl-4,4′,4″-tricarboxylato)ruthenium (II) tri-tetrabutylammonium complex, which is a terbipyridine complex.

### CITATION LIST

### Patent Literature

Patent Literature 1: JP2664194B

### Non Patent Literature

Non Patent Literature 1: Nature, Vol. 353, pp. 737 to 740 (1991)

### SUMMARY OF INVENTION

### Technical Problem

The issue raised by the dye-sensitized solar cell using a metal complex resides in the use of a noble metal such as ruthenium as the raw material for the dye. The mass production of the dye-sensitized solar cell by using such a metal complex raises an issue associated with the restrictions imposed by resources, and renders the solar cell to be expensive so as to hinder the widespread use of such a solar cell.

Such circumstances demand the development of organic dyes not containing noble metals such as ruthenium, as the sensitizing dye in the dye-sensitized solar cell. In general, an organic dye has a larger molar extinction coefficient as compared to complexes such as ruthenium complexes, and further offers a larger degree of freedom in the molecular design; accordingly, the development of a dye having a high photoelectric conversion efficiency is expected.

The present invention has been achieved for the purpose of solving the aforementioned problems; thus, an object of the present invention is to provide an indole compound excellent in photoelectric conversion property, and a photoelectric conversion dye using the indole compound, a semiconductor electrode, a photoelectric conversion element and a photoelectrochemical cell.

### Solution to Problem

According to an aspect of the present invention, an indole compound represented by the following general formula (1) is provided:

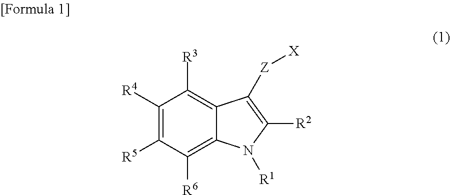

wherein in formula (1), R¹ and R² each independently represent a hydrogen atom, a substituted or unsubstituted alkyl group, a substituted or unsubstituted aryl group or a substituted or unsubstituted heterocyclic group; R³ to R⁶ each independently represent a hydrogen atom, a substituted or unsubstituted alkyl group, a substituted or unsubstituted aryl group, an alkoxy group or a hydroxy group; X represents an organic group having an acidic group; and Z represents a linking group including at least one selected from the group consisting of a substituted or unsubstituted aromatic ring, a substituted or unsubstituted heterocyclic ring, a vinylene group (—CH═CH—) and an ethynylene group (—C≡C—), and wherein in the case where the structure represented by formula (1) involves a tautomer or a stereoisomer, such an isomer is also included in formula (1).

According to another aspect of the present invention, a photoelectric conversion dye including the indole compound is provided.

According to yet another aspect of the present invention, a semiconductor electrode including a semiconductor layer including the photoelectric conversion dye is provided.

According to still yet another aspect of the present invention, a photoelectric conversion element including the semiconductor electrode is provided.

According to further still yet another aspect of the present invention, a photoelectrochemical cell including the photoelectric conversion element is provided.

### Advantageous Effects of Invention

According to an exemplary embodiment, an indole compound excellent in photoelectric conversion property, and a photoelectric conversion dye using the indole compound, a semiconductor electrode, a photoelectric conversion element and a photoelectrochemical cell can be provided.

### BRIEF DESCRIPTION OF DRAWINGS

FIG. 1 is a cross-sectional view schematically illustrating an example of the configuration of the photoelectric conversion element according to an exemplary embodiment.

FIG. 2 is a chart showing the absorption spectrum curve of the indole compound (IN-1) of Example 1 according to the exemplary embodiment.

FIG. 3 is a chart showing the absorption spectrum curve of the indole compound (IN-2) of Example 2 according to the exemplary embodiment.

FIG. 4 is a chart showing the absorption spectrum curve of the indole compound (IN-3) of Example 3 according to the exemplary embodiment.

FIG. 5 is a chart showing the absorption spectrum curve of the indole compound (IN-4) of Example 4 according to the exemplary embodiment.

FIG. 6 is a chart showing the current-voltage curve of a cell using the indole compound (IN-1) of Example 1 according to the exemplary embodiment.

### DESCRIPTION OF EMBODIMENTS

Hereinafter, the exemplary embodiment according to the present invention is described in detail.

<Indole Compound>

The indole compound suitable for the photoelectric conversion dye according to the present exemplary embodiment is the compound represented by the following general formula (1).

In the case where the indole compound according to the present invention has an isomer such as a tautomer or a stereoisomer (for example, a geometrical isomer, a conformer and an optical isomer), any of such isomers can be used in the present invention.

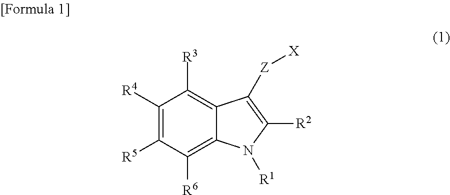

In formula (1), R¹ and R² each independently represent a hydrogen atom, a substituted or unsubstituted alkyl group, a substituted or unsubstituted aryl group or a substituted or unsubstituted heterocyclic group. R¹ preferably represents a substituted or unsubstituted alkyl group, a substituted or unsubstituted aryl group or a substituted or unsubstituted heterocyclic group. Examples of the substituted or unsubstituted alkyl group include: alkyl groups having 1 to 8 carbon atoms such as a methyl group, an ethyl group, a propyl group, an n-butyl group, a pentyl group, a hexyl group, a heptyl group and an octyl group; and aralkyl groups such as a benzyl group. Examples of the substituent bonded to the alkyl group include a hydroxy group, an alkoxy group (for example, an alkoxy group having 1 to 4 carbon atoms) and a phenyl group. Example of the substituted or unsubstituted aryl group include: substituted or unsubstituted aryl groups having 6 to 22 carbon atoms such as a phenyl group, a tolyl group, a 4-t-butylphenyl group, a 3,5-di-t-butylphenyl group, a 4-methoxyphenyl group, a 4-(N,N-dimethylamino)phenyl group, a 4-(N,N-diphenylamino)phenyl group, α,α-dimethylbenzylphenyl group and a biphenyl group, wherein the number of carbon atoms does not include the number of carbon atoms in the substituent(s). Examples of the substituent bonded to the aryl group include: an alkyl group (for example, an alkyl group having 1 to 8 carbon atoms), a hydroxy group, an alkoxy group (for example, an alkoxy group having 1 to 12 carbon atoms or 1 to 4 carbon atoms), an N,N-dialkylamino group (the alkyl group moiety is, for example, an alkyl group having 1 to 12 or 1 to 8 carbon atoms) and an N,N-diphenylamino group. Examples of the substituted or unsubstituted heterocyclic group include: a thienyl group, a furyl group, a pyrrolyl group, an indolyl group and a carbazoyl group. Examples of the substituent bonded to the heterocyclic group include an alkyl group (for example, an alkyl group having 1 to 8 carbon atoms), a hydroxy group and an alkoxy group (for example, an alkoxy group having 1 to 8 carbon atoms).

R³ to R⁶ in formula (1) each independently represent a hydrogen atom, a substituted or unsubstituted alkyl group (a linear or branched alkyl group), a substituted or unsubstituted aryl group, an alkoxy group or a hydroxy group. Examples of the substituted or unsubstituted alkyl group include alkyl groups having 1 to 8 carbon atoms such as a methyl group, an ethyl group, a propyl group, an n-butyl group, an isobutyl group, a sec-butyl group, a tert-butyl group, a pentyl group, a hexyl group, a heptyl group, an octyl group. Examples of the substituent bonded to the alkyl group include a hydroxy group and an alkoxy group (for example, an alkoxy group having 1 to 4 carbon atoms). Examples of the substituted or unsubstituted aryl group include substituted or unsubstituted aryl groups having 6 to 22 carbon atoms such as a phenyl group, a tolyl group, 4-t-butylphenyl group, 3,5-di-t-butylphenyl group, 4-methoxyphenyl group and a 4-(N,N-dimethylamino)phenyl group. Examples of the substituent bonded to the aryl group include an alkyl group (for example, an alkyl group having 1 to 8 carbon atoms), a hydroxy group, an alkoxy group (for example, an alkoxy group having 1 to 4 carbon atoms) and an N,N-dialkylamino group (the alkyl group moiety is, for example, an alkyl group having 1 to 8 carbon atoms). Examples of the alkoxy group include alkoxy group having 1 to 4 carbon atoms such as a methoxy group, an ethoxy group, a propoxy group and a butoxy group.

X in formula (1) represents an organic group having an acidic group. Examples of the acidic group possessed by the organic group X include a carboxy group, a sulfonic acid group or a phosphonic acid group, or the salts of these; among these, a carboxy group and the salts thereof are particularly preferable. When the acidic group is a salt, the acidic group is preferably a salt of a monovalent or divalent metal, an ammonium salt or an organic ammonium salt. Examples of the salt of a monovalent or divalent metal include: salts of alkali metals such as Li, Na, K and Cs; and salts of alkali earth metals such as Mg, Ca and Sr. Examples of the organic group of the organic ammonium group include an alkyl group having 1 to 8 carbon atoms, an alkenyl group having 1 to 8 carbon atoms and an aryl group having 6 to 12 carbon atoms.

The indole compound represented by the general formula (1) preferably has a functional group capable of being adsorbed to the semiconductor layer from the viewpoint of being adsorbed to the semiconductor layer used in the semiconductor electrode, wherein the acidic group of the organic group X can play the role of such a functional group. Specific examples of the organic group X having an acidic group are shown in the chemical formulas (X1) to (X16), but the organic group X having an acidic group is not limited to the specific examples. These organic groups X each have, in addition to the acidic group, a carbon-carbon double bond; to one of the carbon atoms in the carbon-carbon double bond, one of the bonding hands of the linking group Z is bonded, and to the other of the carbon atoms in the carbon-carbon double bond, any one of a cyano group, a carbonyl group, the carbon atom of another carbon-carbon double bond and the carbon atom of a carbon-nitrogen bond is bonded.

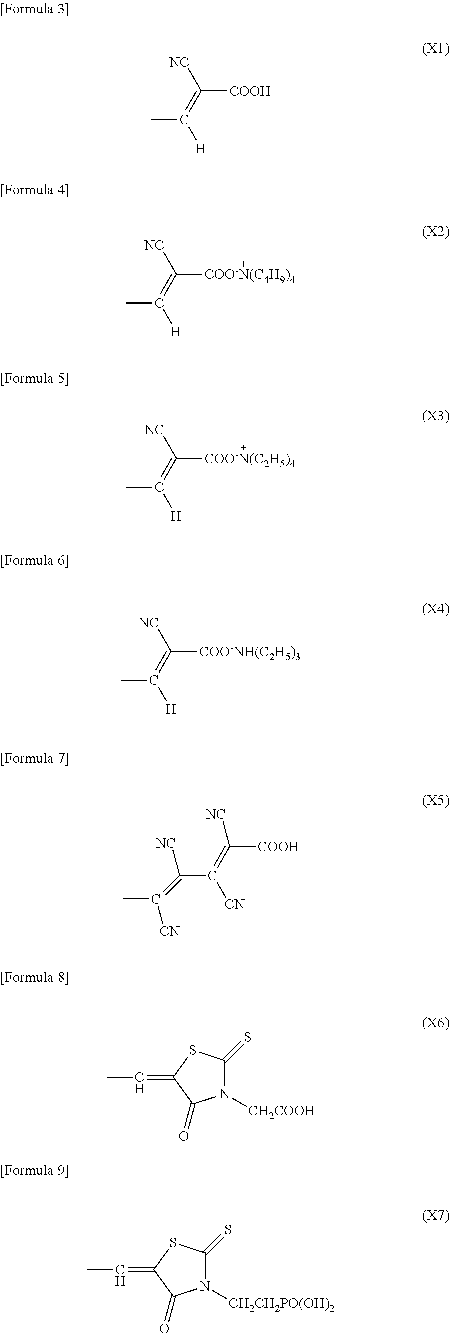

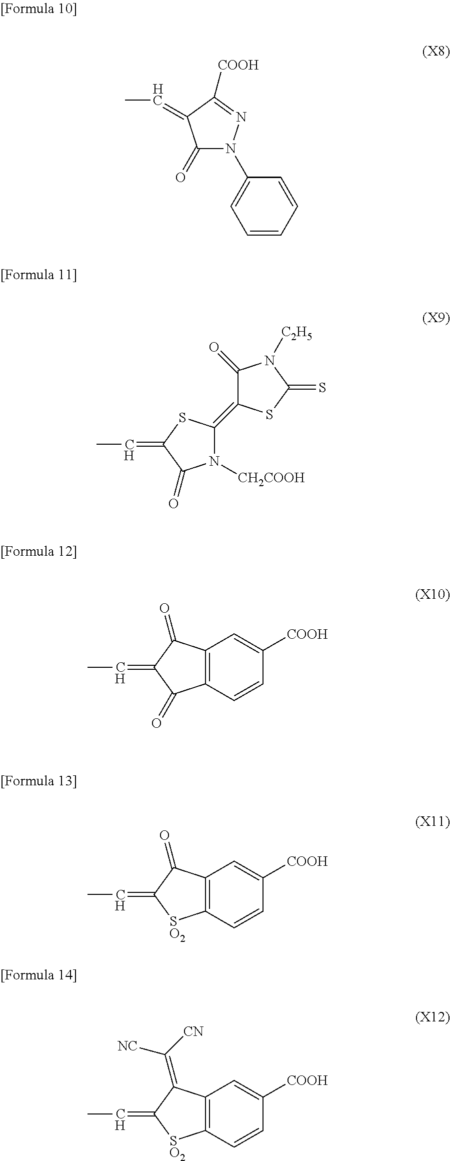

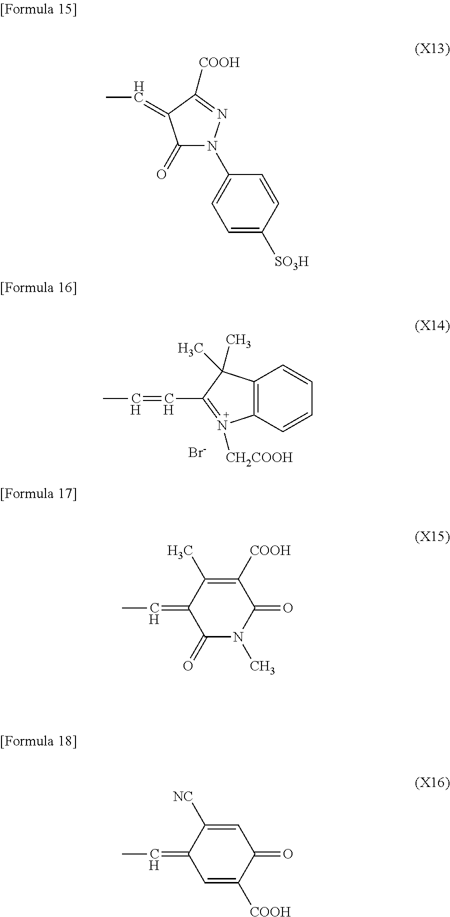

The organic group X having an acidic group is preferably a group represented by the following general formula (2).

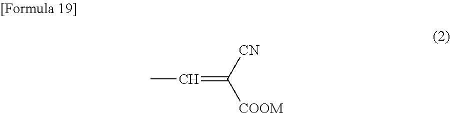

In formula (2), M represents a hydrogen atom or a salt-forming cation.

Examples of the salt-forming cation include various cations capable of forming a salt with carboxy group. Examples of such a cation include: an ammonium cation (NH⁴⁺); an organic ammonium cation (A¹A²A³A⁴N⁺, IN wherein A¹ to A⁴ each represent a hydrogen atom or an organic group, and at least one of A¹ to A⁴ is an organic group) derived from an amine; alkali metal ions such as Li⁺, Na⁺, K⁺ and Cs⁺; and alkali earth metal ions such as Mg²⁺, Ca²⁺ and Sr²⁺). Examples of the organic group of the organic ammonium cation include an alkyl group having 1 to 8 carbon atoms, an alkenyl group having 1 to 8 carbon atoms and an aryl group having 6 to 12 carbon atoms.

Z in formula (1) represents a linking group including at least one selected from the group consisting of a substituted or unsubstituted aromatic ring, a substituted or unsubstituted heterocyclic ring, a vinylene group (—CH═CH—) and an ethynylene group (—C≡C—).

Examples of the substituent in the aromatic ring or the heterocyclic ring of the linking group Z include a substituted or unsubstituted alkyl group (a linear or branched alkyl group) or a substituted or unsubstituted alkoxy group (a linear or branched alkyl group). Examples of the substituted or unsubstituted alkyl group include alkyl groups having 1 to 8 carbon atoms such as a methyl group, an ethyl group, a propyl group, an n-butyl group, a pentyl group, a hexyl group, a heptyl group and an octyl group. Examples of the substituent bonded to the alkyl group include a hydroxy group and an alkoxy group (for example, an alkoxy group having 1 to 4 carbon atoms). Examples of the alkoxy group of the aromatic ring or the heterocyclic ring include alkoxy groups having 1 to 4 carbon atoms such as a methoxy group, an ethoxy group, a propoxy group and a butoxy group.

The linking group Z is not particularly limited, but is preferably an atomic group capable of being conjugated with the indole ring to which the linking group Z is bonded and with the organic group X having an acidic group. As the linking group Z, a linking group having at least one heterocyclic ring selected from the group consisting of a thiophene ring, a furan ring and a pyrrole ring can be preferably used. Such a linking group Z is preferably a linking group having at least the structure represented by the following general formula (3).

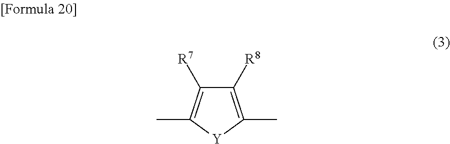

In formula (3), R⁷ and R⁸ each independently represent a hydrogen atom, a substituted or unsubstituted alkyl group (a linear or branched alkyl group), or a substituted or unsubstituted alkoxy group (a linear or branched alkyl group) and R⁷ and R⁸ may be linked to each other to form a ring. Examples of the substituted or unsubstituted alkyl group include alkyl groups having 1 to 8 carbon atoms such as a methyl group, an ethyl group, a propyl group, an n-butyl group, a pentyl group, a hexyl group, a heptyl group and an octyl group. Examples of the substituent bonded to the alkyl group include a hydroxy group and an alkoxy group (for example, an alkoxy group having 1 to 4 carbon atoms). Examples of the alkoxy group as R⁷ or R⁸ include alkoxy groups having 1 to 4 carbon atoms such as a methoxy group, an ethoxy group, a propoxy group and a butoxy group. Examples of the substituent bonded to the alkoxy group include a hydroxy group.

In formula (3), Y represents an oxygen atom, a sulfur atom or NRa, and Ra represents a hydrogen atom, a substituted or unsubstituted alkyl group (a linear or branched alkyl group) or a substituted or unsubstituted aryl group. Examples of the substituted or unsubstituted alkyl group include: alkyl groups having 1 to 8 carbon atoms such as a methyl group, an ethyl group, a propyl group, an n-butyl group, a pentyl group, a hexyl group, a heptyl group and an octyl group; and aralkyl groups such as a benzyl group. Examples of the substituent bonded to the alkyl group include a hydroxy group, an alkoxy group (for example, an alkoxy group having 1 to 4 carbon atoms) and a phenyl group. Examples of the substituted or unsubstituted aryl group include substituted or unsubstituted aryl groups having 6 to 22 carbon atoms such as a phenyl group, a tolyl group, a 4-t-butylphenyl group, a 3,5-di-t-butylphenyl group, a 4-methoxyphenyl group and a 4-(N,N-dimethylamino)phenyl group. Examples of the substituent bonded to the aryl group include an alkyl group (for example, an alkyl group having 1 to 8 carbon atoms), a hydroxy group, an alkoxy group (for example, an alkoxy group having 1 to 4 carbon atoms) and an N,N-dialkylamino group (the alkyl group moiety is, for example, an alkyl group having 1 to 8 carbon atoms).

The linking group Z and the indole ring bonded to the linking group Z in formula (1) preferably form a conjugated structure, and further, the linking group Z and the organic group X bonded to the linking group Z more preferably form a conjugated structure.

Specific examples of such a linking group Z include, without being limited to, the linking groups Z shown in the chemical formulas (Z1) to (Z29). The examples each include a heterocyclic ring and the ring has a bonding hand. When there are a plurality of heterocyclic rings, the carbon atoms constituting the heterocyclic rings are directly bonded to each other, or the heterocyclic rings bonded to each other to form a condensed ring, and thus any one of such heterocyclic rings has a bonding hand. The linking group may be a linking group formed by linking the two or more linking groups selected from these linking groups.

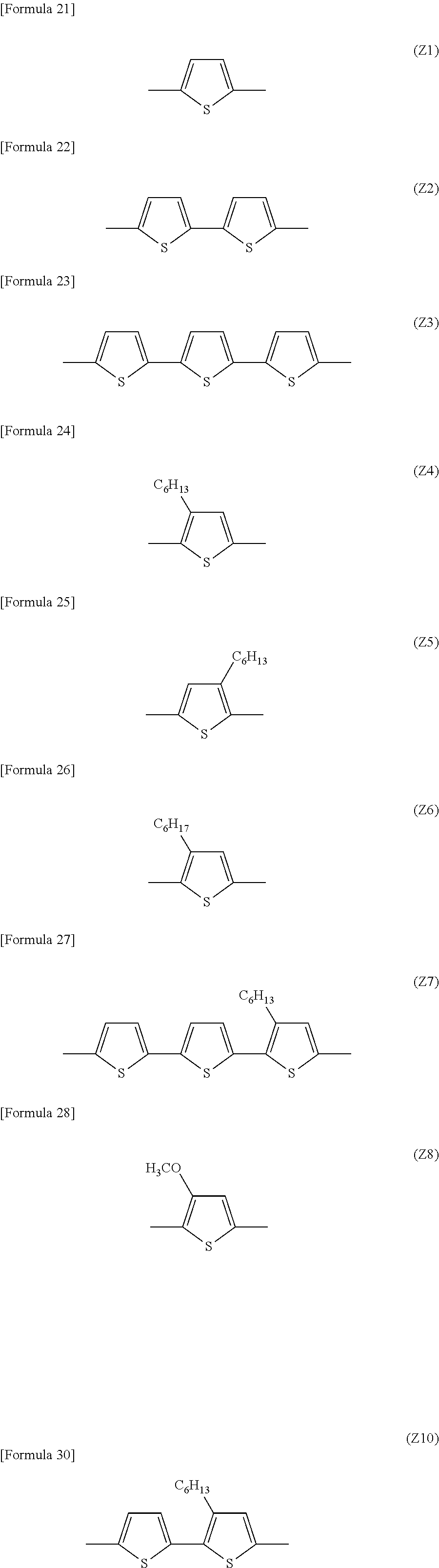

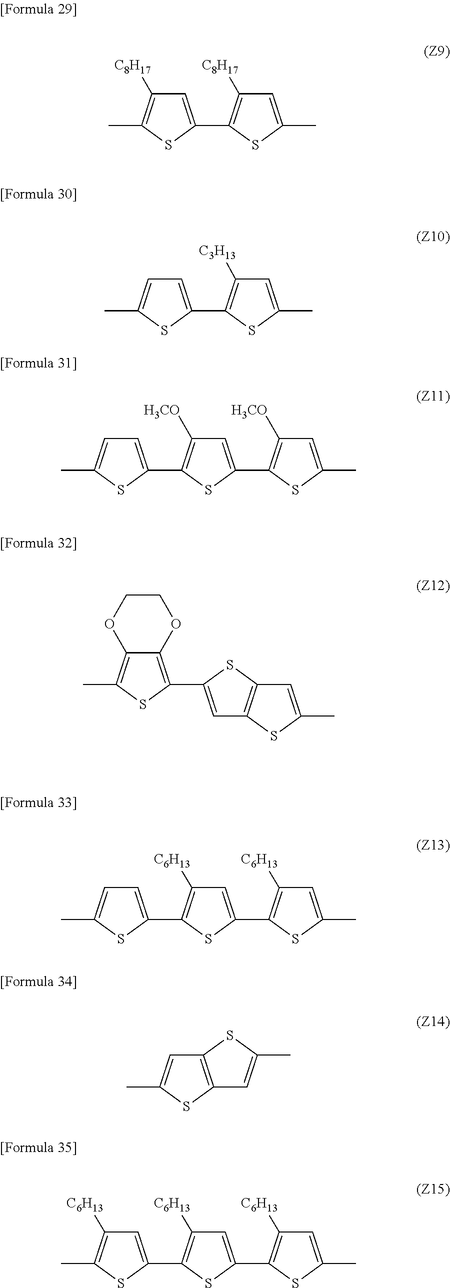

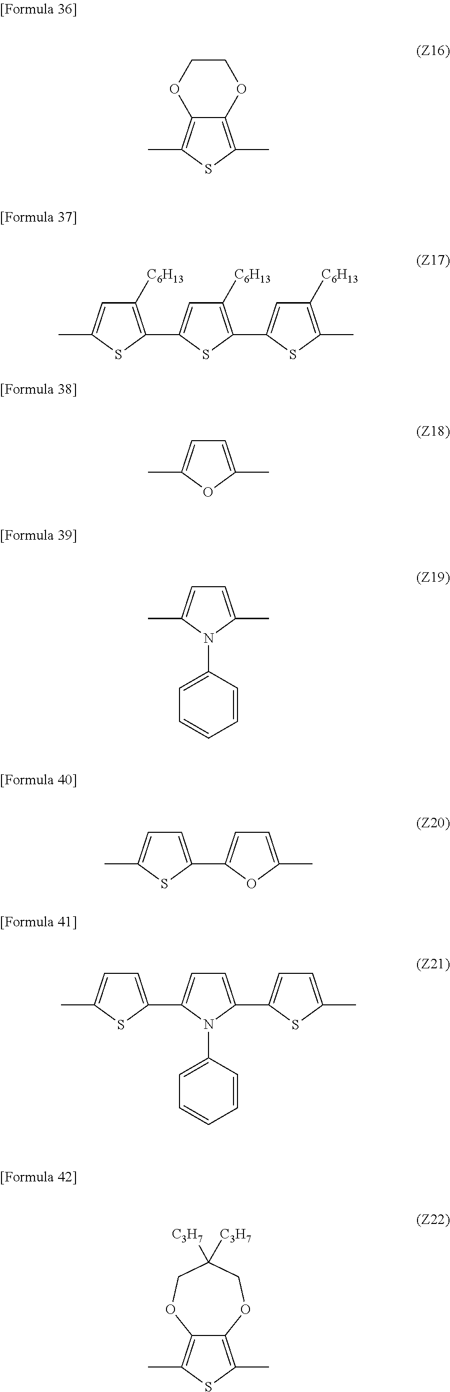

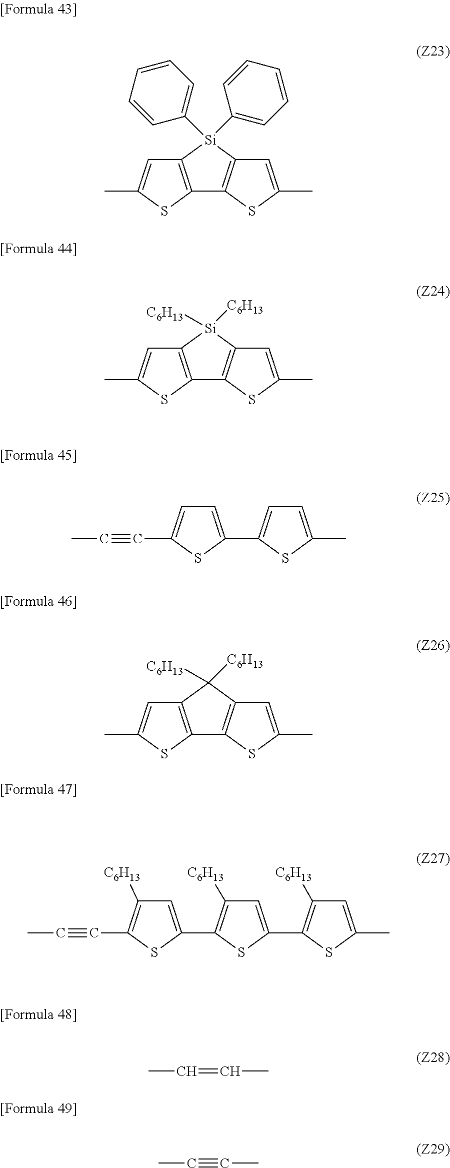

In the above-described indole compounds (inclusive of the tautomer(s) and the stereoisomer(s) thereof) represented by the general formula (1), examples of the combination of Z and X in the formula include the combinations (a-1) to (a-29), (b-1) to (b-29), (c-1) to (c-29), (d-1) to (d-16), (e-1) to (e-16) and (f-1) to (f-16) respectively shown in Tables 1 to 6.

TABLE 1

| | X | Z |
|---|---|---|
| a-1 | X1 | Z1 |
| a-2 | X1 | Z2 |
| a-3 | X1 | Z3 |
| a-4 | X1 | Z4 |
| a-5 | X1 | Z5 |
| a-6 | X1 | Z6 |
| a-7 | X1 | Z7 |
| a-8 | X1 | Z8 |
| a-9 | X1 | Z9 |
| a-10 | X1 | Z10 |
| a-11 | X1 | Z11 |
| a-12 | X1 | Z12 |
| a-13 | X1 | Z13 |
| a-14 | X1 | Z14 |
| a-15 | X1 | Z15 |
| a-16 | X1 | Z16 |
| a-17 | X1 | Z17 |
| a-18 | X1 | Z18 |
| a-19 | X1 | Z19 |
| a-20 | X1 | Z20 |
| a-21 | X1 | Z21 |
| a-22 | X1 | Z22 |
| a-23 | X1 | Z23 |
| a-24 | X1 | Z24 |
| a-25 | X1 | Z25 |
| a-26 | X1 | Z26 |
| a-27 | X1 | Z27 |
| a-28 | X1 | Z28 |
| a-29 | X1 | Z29 |

TABLE 2

| | X | Z |
|---|---|---|
| b-1 | X2 | Z1 |
| b-2 | X2 | Z2 |
| b-3 | X2 | Z3 |
| b-4 | X2 | Z4 |
| b-5 | X2 | Z5 |
| b-6 | X2 | Z6 |
| b-7 | X2 | Z7 |
| b-8 | X2 | Z8 |
| b-9 | X2 | Z9 |
| b-10 | X2 | Z10 |
| b-11 | X2 | Z11 |
| b-12 | X2 | Z12 |
| b-13 | X2 | Z13 |
| b-14 | X2 | Z14 |
| b-15 | X2 | Z15 |
| b-16 | X2 | Z16 |
| b-17 | X2 | Z17 |
| b-18 | X2 | Z18 |
| b-19 | X2 | Z19 |
| b-20 | X2 | Z20 |
| b-21 | X2 | Z21 |
| b-22 | X2 | Z22 |
| b-23 | X2 | Z23 |
| b-24 | X2 | Z24 |
| b-25 | X2 | Z25 |
| b-26 | X2 | Z26 |
| b-27 | X2 | Z27 |
| b-28 | X2 | Z28 |
| b-29 | X2 | Z29 |

TABLE 3

| | X | Z |
|---|---|---|
| c-1 | X9 | Z1 |
| c-2 | X9 | Z2 |
| c-3 | X9 | Z3 |
| c-4 | X9 | Z4 |
| c-5 | X9 | Z5 |
| c-6 | X9 | Z6 |
| c-7 | X9 | Z7 |
| c-8 | X9 | Z8 |
| c-9 | X9 | Z9 |
| c-10 | X9 | Z10 |
| c-11 | X9 | Z11 |
| c-12 | X9 | Z12 |
| c-13 | X9 | Z13 |
| c-14 | X9 | Z14 |
| c-15 | X9 | Z15 |
| c-16 | X9 | Z16 |
| c-17 | X9 | Z17 |
| c-18 | X9 | Z18 |
| c-19 | X9 | Z19 |
| c-20 | X9 | Z20 |
| c-21 | X9 | Z21 |
| c-22 | X9 | Z22 |
| c-23 | X9 | Z23 |
| c-24 | X9 | Z24 |
| c-25 | X9 | Z25 |
| c-26 | X9 | Z26 |
| c-27 | X9 | Z27 |
| c-28 | X9 | Z28 |
| c-29 | X9 | Z29 |

TABLE 4

| | X | Z |
|---|---|---|
| d-1 | X3 | Z13 |
| d-2 | X4 | Z13 |
| d-3 | X5 | Z13 |
| d-4 | X6 | Z13 |
| d-5 | X7 | Z13 |
| d-6 | X8 | Z13 |
| d-7 | X10 | Z13 |
| d-8 | X11 | Z13 |
| d-9 | X12 | Z13 |
| d-10 | X13 | Z13 |
| d-11 | X14 | Z13 |
| d-12 | X15 | Z13 |
| d-13 | X16 | Z13 |

TABLE 5

| | X | Z |
|---|---|---|
| e-1 | X3 | Z24 |
| e-2 | X4 | Z24 |
| e-3 | X5 | Z24 |
| e-4 | X6 | Z24 |
| e-5 | X7 | Z24 |
| e-6 | X8 | Z24 |
| e-7 | X10 | Z24 |
| e-8 | X11 | Z24 |
| e-9 | X12 | Z24 |
| e-10 | X13 | Z24 |
| e-11 | X14 | Z24 |
| e-12 | X15 | Z24 |
| e-13 | X16 | Z24 |

TABLE 6

| | X | Z |
|---|---|---|
| f-1 | X3 | Z26 |
| f-2 | X4 | Z26 |
| f-3 | X5 | Z26 |
| f-4 | X6 | Z26 |
| f-5 | X7 | Z26 |
| f-6 | X8 | Z26 |
| f-7 | X10 | Z26 |
| f-8 | X11 | Z26 |
| f-9 | X12 | Z26 |
| f-10 | X13 | Z26 |
| f-11 | X14 | Z26 |
| f-12 | X15 | Z26 |
| f-13 | X16 | Z26 |

The indole compounds according to the exemplary embodiment of the present invention are preferably the compounds (inclusive of the tautomers or the stereoisomers) represented by the following formulas IN-1 to IN-5 and IN-6 to IN-15, and the salts of these. The indole compounds represented by the formulas IN-1 to IN-5 are described more specifically in below-described Examples. The indole compounds represented by the formulas IN-6 to IN-15 can be easily produced and used in conformity with below-described Examples and the below-described production methods related to the indole compounds represented by the formulas IN-1 to IN-5. The indole compound of the present invention is not limited to these examples; indole compounds having a structure obtained by appropriately combining Zs and Xs in the formulas can also be used.

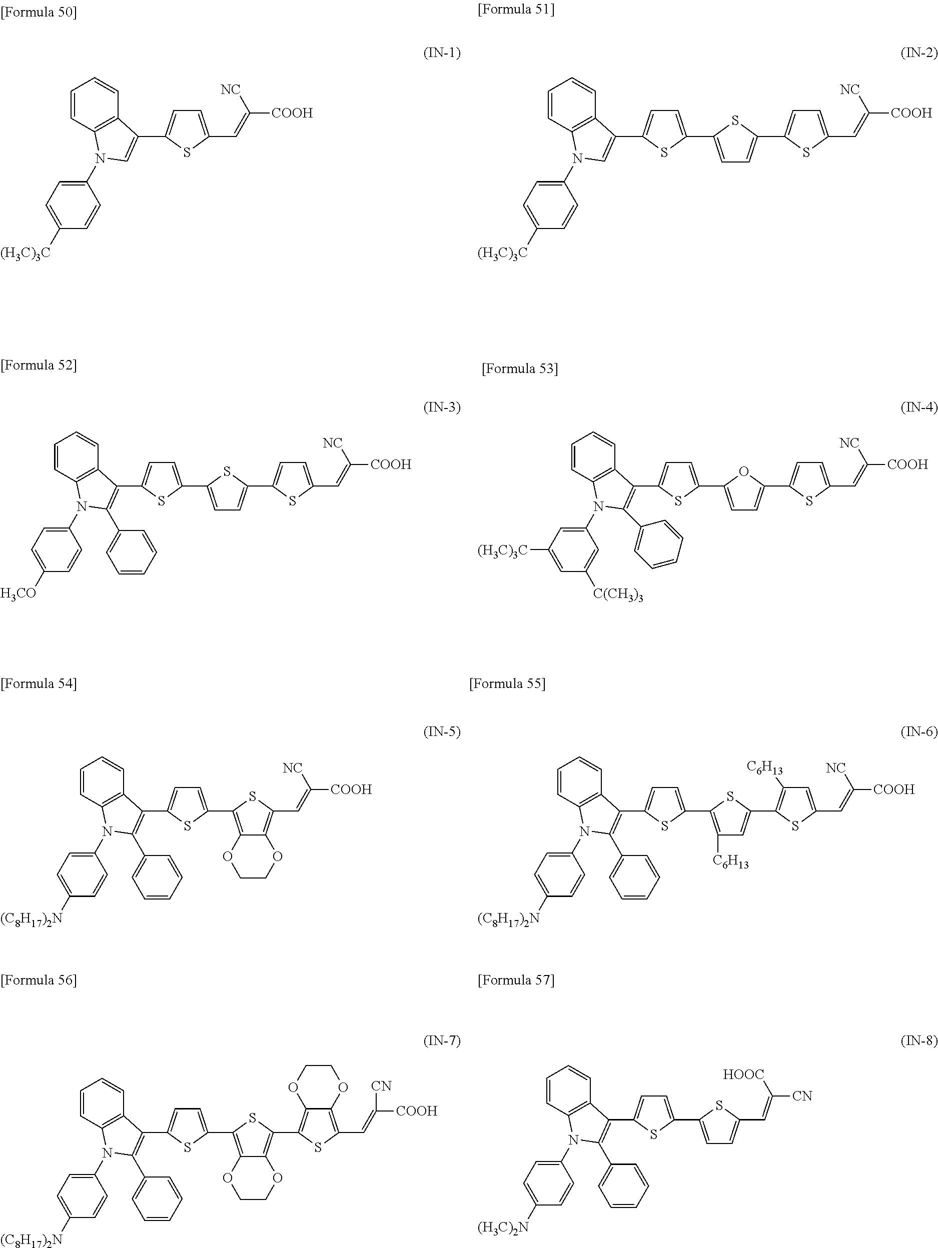

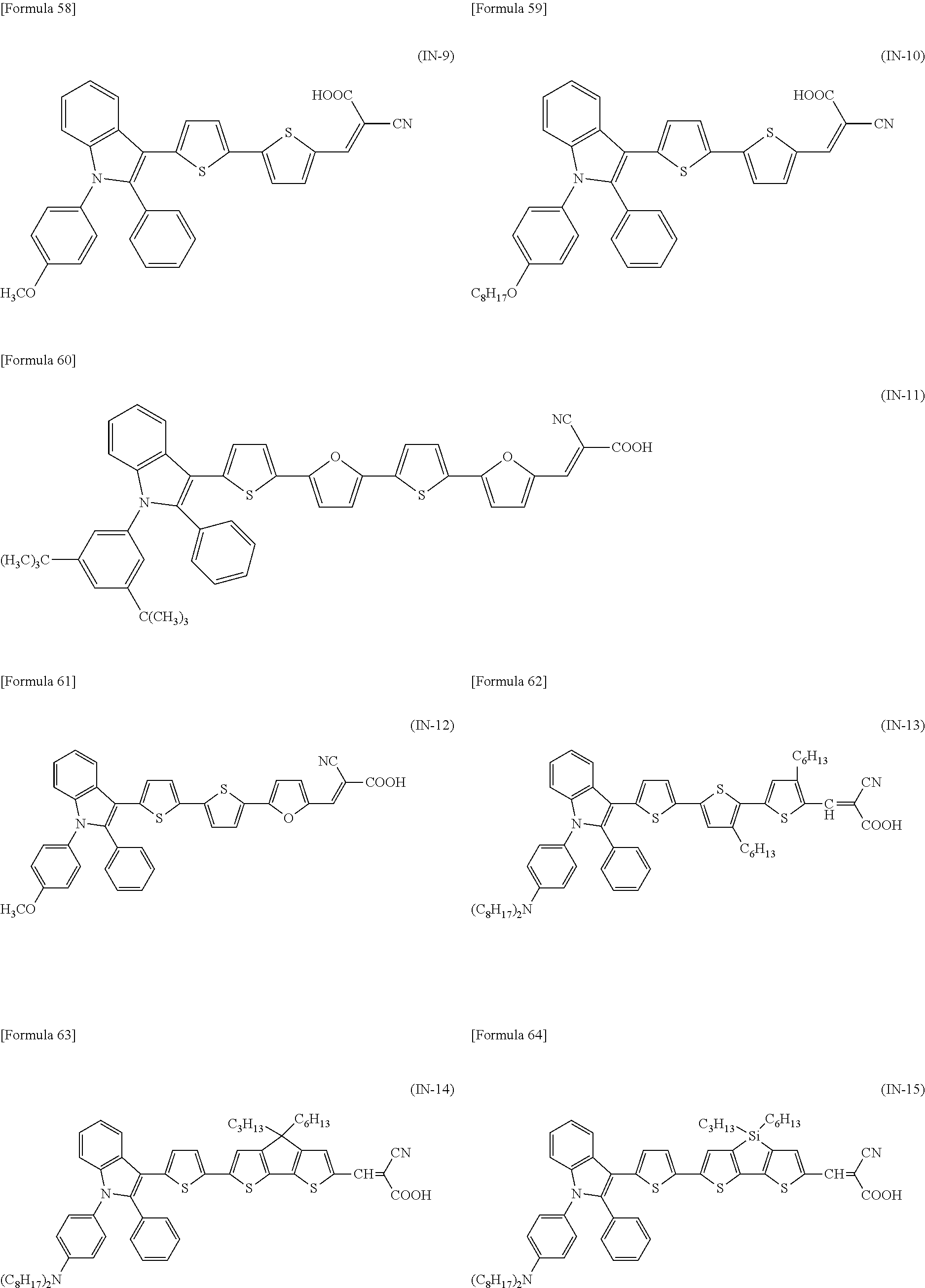

<Photoelectric Conversion Element>

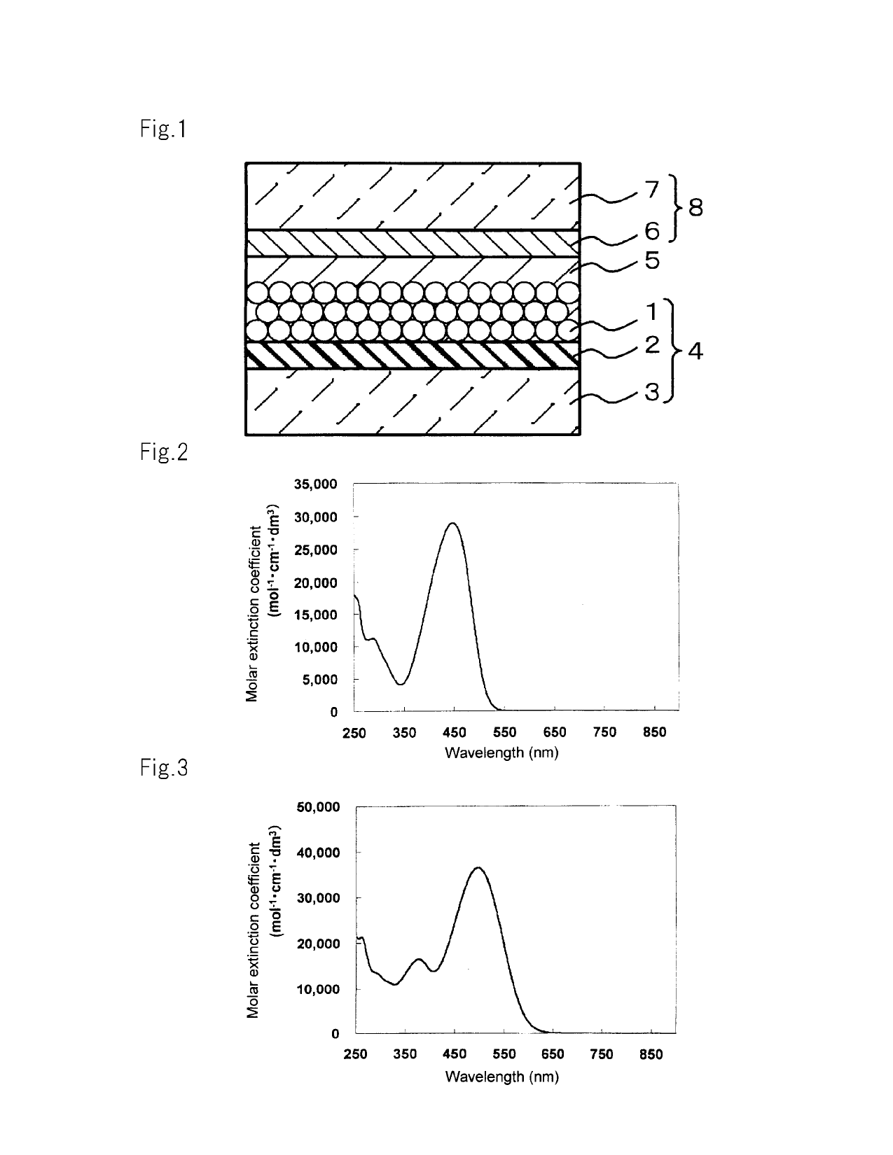

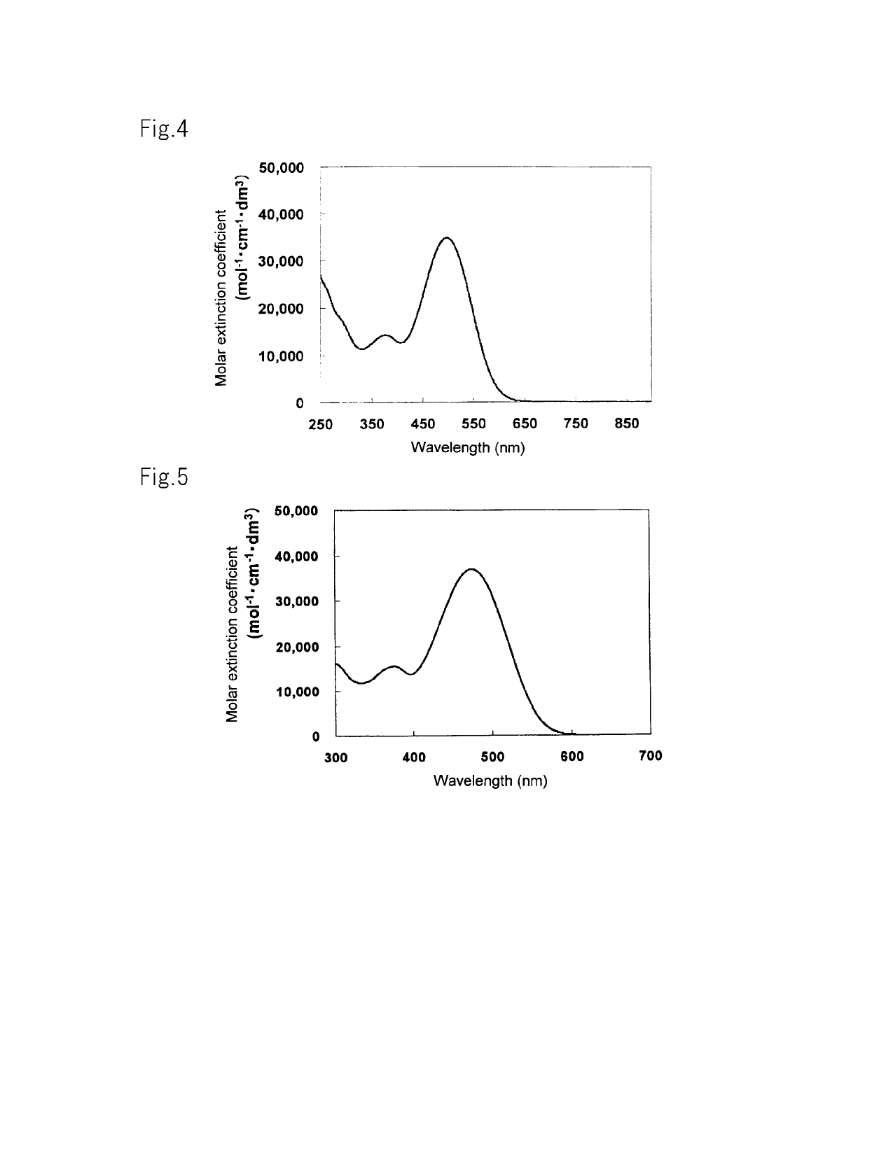

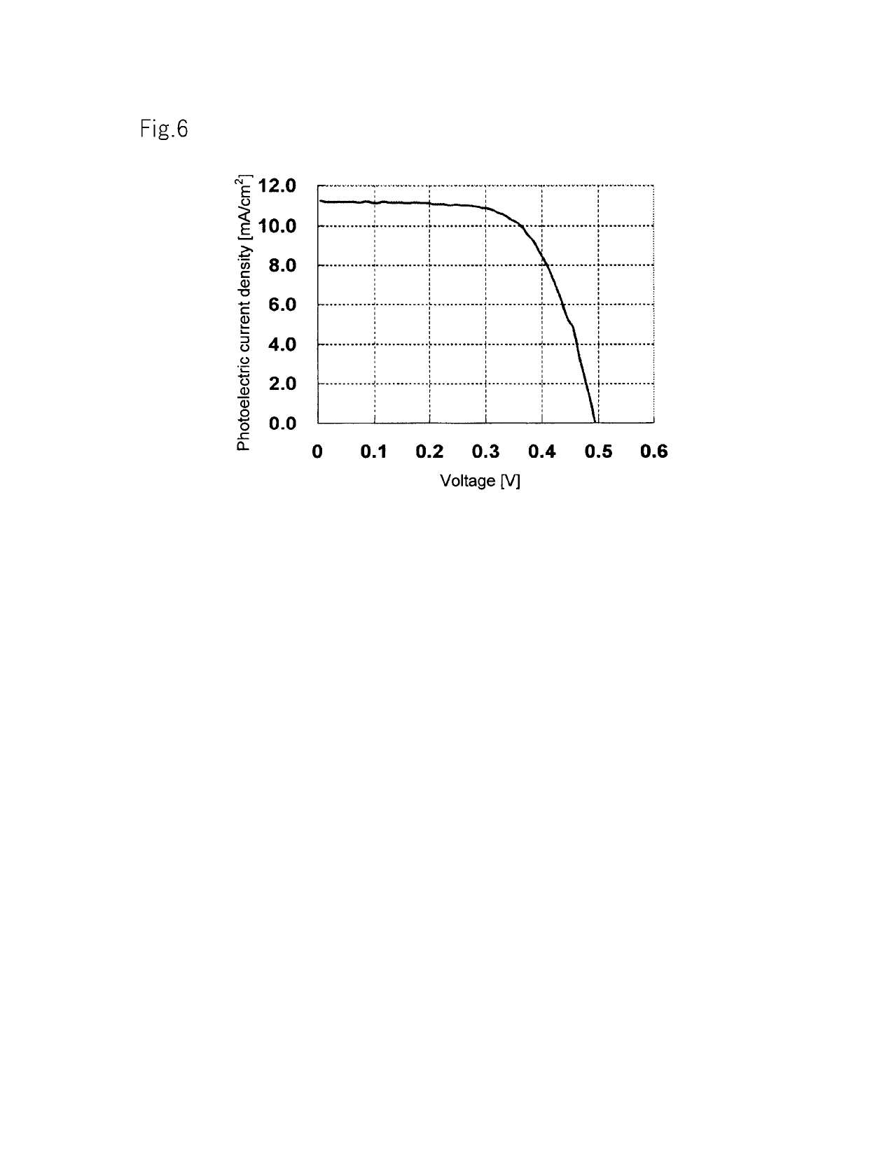

FIG. 1 schematically shows the cross sectional structure of an example of the photoelectric conversion element according to the present exemplary embodiment. The photoelectric conversion element shown in FIG. 1 includes a semiconductor electrode 4, a counter electrode 8, and an electrolyte layer (a charge transport layer) 5 held between both electrodes. The semiconductor electrode 4 includes a conductive substrate including a light-transmitting substrate 3 and a transparent conductive layer 2, and a semiconductor layer 1. The counter electrode 8 includes a catalyst layer 6 and a substrate 7. To the semiconductor layer 1, a dye is adsorbed.

Light incident to the photoelectric conversion element excites the dye adsorbed to the semiconductor layer 1 and the dye ejects electrons. The electrons migrate into the conduction band of the semiconductor and further migrate into the transparent conductive layer 2. The electrons in the transparent conductive layer 2 migrate into the counter electrode 8, by way of an external circuit (not shown). The dye which has emitted an electron (the oxidized dye) accepts an electron (is reduced) from the electrolyte layer 5, to get back to the original condition and the dye is regenerated. On the other hand, the electron which has migrated into the counter electrode is imparted to the electrolyte layer to reduce the electrolyte. In this way, the photoelectric conversion element has a configuration to function as a cell. Hereinafter, each of the constituent elements is described by taking the photoelectric conversion element shown in FIG. 1 as an example.

<Semiconductor Electrode>

The semiconductor electrode 4 includes a conductive substrate including the light-transmitting substrate 3 and the transparent conductive layer 2, and the semiconductor layer 1. As shown in FIG. 1, the light-transmitting substrate 3, the transparent conductive layer 2 and the semiconductor layer 1 are laminated in this order from the outside toward the inside of the element. To the semiconductor layer 1, a dye (not shown) is adsorbed.

<Conductive Substrate>

The conductive substrate of the semiconductor electrode 4 may be of a single layer structure in which the substrate itself has conductivity or of a double layer structure in which a conductive layer is formed on the substrate. The conductive substrate of the photoelectric conversion element shown in FIG. 1 has a double layer structure in which the transparent conductive layer 2 is formed on the light-transmitting substrate 3.

Examples of the substrate used as the conductive substrate include a glass substrate, a plastic substrate and a metal plate; among these, a substrate having a high light transmittance such as a transparent plastic substrate is particularly preferable. Examples of the material for the transparent plastic substrate include polyethylene terephthalate (PET), polyethylene naphthalate (PEN), polycarbonate (PC), polycycloolefin and polyphenylenesulfide.

The conductive layer (for example, the transparent conductive layer 2) formed on the substrate (for example, the light-transmitting substrate 3) is not particularly limited, but is a transparent conductive layer constituted with a transparent material such as indium-tin oxide (ITO), fluorine-doped tin oxide (FTO), indium zinc oxide (IZO) and tin oxide (SnO₂). The conductive layer formed on the substrate can be formed in a film-like form over the whole surface of the substrate or on a part of the surface of the substrate. The thickness of the conductive layer can be appropriately selected, but is preferably about 0.02 μm or more and 10 μm or less. Such a conductive layer can be formed by taking advantage of the common film formation techniques.

The conductive substrate in the present exemplary embodiment can use a metal lead wire for the purpose of decreasing the resistance of the conductive substrate. Examples of the material of the metal lead wire include metals such as aluminum, copper, gold, silver, platinum and nickel. The metal lead wire can be prepared by a technique such as vapor deposition or sputtering. After the metal lead wire is formed on the substrate (for example, the light-transmitting substrate 3), a conductive layer (for example, the transparent conductive layer 2 made of a material such as ITO or FTO) can be disposed over the metal lead wire. Alternatively, after a conductive layer (for example, the transparent conductive layer 2) is disposed on the substrate (for example, the light-transmitting substrate 3), the metal lead wire may be prepared on the conductive layer.

The following description of the present exemplary embodiment is based on the example using as the conductive substrate of the semiconductor electrode, the conductive substrate having a double layer structure in which the transparent conductive layer 2 is formed on the light-transmitting substrate 3; however, the present exemplary embodiment is not limited to this example.

<Semiconductor Layer>

As the materials for constituting the semiconductor layer 1, for example, element semiconductors such as silicon and germanium, compound semiconductors such as metal chalcogenides and compounds having perovskite structure can be used.

Examples of the metal chalcogenide include: oxides of metals such as titanium, tin, zinc, iron, tungsten, indium, zirconium, vanadium, niobium, tantalum, strontium, hafnium, cerium and lanthanum; sulfides of metals such as cadmium, zinc, lead, silver, antimony and bismuth; selenides of metals such as cadmium and lead; and telluride of cadmium. Examples of other compound semiconductors include: phosphides of metals such as zinc, gallium, indium and cadmium; gallium arsenide; copper-indium selenide; and copper-indium sulfide. Examples of the compounds having the perovskite structure include commonly known semiconductor compounds such as barium titanate, strontium titanate and potassium niobate. These semiconductor materials can be used each alone or as mixtures of two or more thereof.

Among these semiconductor materials, from the viewpoint of conversion efficiency, stability and safety, the semiconductor materials containing titanium oxide or zinc oxide are preferable, and the semiconductor materials containing titanium oxide are more preferable. Examples of titanium oxide include various types of titanium oxide such as anatase-type titanium oxide, rutile-type titanium oxide, amorphous titanium oxide, metatitanic acid and orthotitanic acid; additionally, titanium oxide-containing composites can also be used. Among these, anatase-type titanium oxide is preferable from the viewpoint of further improving the stability of the photoelectric conversion.

Examples of the form of the semiconductor layer include: porous semiconductor layers obtained by sintering materials such as semiconductor fine particles; and thin-film-like semiconductor layers obtained by the sol-gel method, the sputtering method, the spray pyrolysis method, and so on. The form of the semiconductor layer may also be a fibrous semiconductor layer or a semiconductor layer made of a needle-like crystal. These forms of the semiconductor layer can be appropriately selected according to the intended use of the photoelectric conversion element. Among these, from the viewpoint of the factors such as the dye adsorption amount, semiconductor layers large in specific surface area such as a porous semiconductor layer and a semiconductor layer made of a needle-like crystal are preferable. In particular, porous semiconductor layers formed of semiconductor fine particles are preferable from the viewpoint of enabling the regulation of, for example, the utilization rate of the incident light on the basis of the particle size of the semiconductor fine particles. The semiconductor layer may be of a single layer or of multiple layers. The adoption of a set of multiple layers allows a sufficiently thick semiconductor layer to be more easily formed. In the case where the porous semiconductor layer formed of semiconductor fine particles is of multiple layers, the semiconductor layer may be composed of a plurality of semiconductor layers different from each other in the average particle size of the semiconductor fine particles. For example, the average particle size of the semiconductor fine particles of the semiconductor layer (a first semiconductor layer) nearer to the incident light side may be made smaller than the average particle size of the semiconductor fine particles of the semiconductor layer (a second semiconductor layer) farther from the incident light side. In this way, the first semiconductor layer can be made to absorb a larger amount of light; and at the same time, the light transmitting through the first semiconductor layer can be efficiently scattered in the second semiconductor layer so as to get back to the first semiconductor layer, the light getting back to the first semiconductor layer is absorbed by the first semiconductor layer, and thus, the light absorptance of the whole semiconductor layer can be more improved.

The thickness of the semiconductor layer is not particularly limited; however, from the viewpoint of the transmittance and the conversion rate, the thickness of the semiconductor layer can be set at, for example, 0.5 μm or more and 45 μm or less. The specific surface area of the semiconductor layer can be set at, for example, 10 m²/g or more and 200 m²/g or less, from the viewpoint of allowing the semiconductor layer to adsorb a large amount of dye.

In the case of the constitution in which a dye is adsorbed to a porous semiconductor layer, from the viewpoint of the occurrence of charge transportation due to further sufficient diffusion of the ions in the electrolyte, the porosity of the porous semiconductor layer is preferably set at, for example, 40% or more and 80% or less. The porosity as referred to herein means the proportion, in terms of percentage, of the volume occupied by the pores in the semiconductor layer in relation to the volume of the semiconductor layer.

<Method for Forming Semiconductor Layer>

Next, the method for forming the semiconductor layer 1 is described by taking the porous semiconductor layer as an example. The porous semiconductor layer can be formed, for example, as follows.

First, semiconductor fine particles are added, together with an organic compound such as a resin and a dispersant, to a dispersion medium such as an organic solvent or water to prepare a suspension. Then, the suspension is applied to a conductive substrate (the transparent conductive layer 2 in FIG. 1), dried and fired to yield a semiconductor layer. The addition of the organic compound to the dispersion medium together with the semiconductor fine particles enables to ensure further sufficient empty spaces (voids) in the porous semiconductor layer through the combustion of the organic compound at the time of firing. The porosity can be varied by controlling the molecular weight and the addition amount of the organic compound to be combusted at the time of firing.

The organic compound to be used is not particularly limited as long as the organic compound is dissolved in the suspension, and is combusted at the time of firing and thus can be removed. Examples of such an organic compound include: polyethylene glycol, cellulose ester resin, cellulose ether resin, epoxy resin, urethane resin, phenolic resin, polycarbonate resin, polyarylate resin, polyvinylbutyral resin, polyester resin, polyvinylformal resin and silicon resin. Examples of such an organic compound also include polymers and copolymers of vinyl compounds such as styrene, vinyl acetate, acrylic acid ester and methacrylic acid ester. The type and the mixing amount of the organic compound can be appropriately selected according to the factors such as the type and the condition of the fine particles to be used and the compositional ratios and the total weight of the suspension. When the proportion of the semiconductor fine particles is 10% by mass or more in relation to the total weight of the whole suspension, the strength of the prepared film can be made furthermore sufficiently strong; when the proportion of the semiconductor fine particles is 40% by mass or less in relation to the total weight of the whole suspension, the porous semiconductor layer having a large porosity can be obtained furthermore stably; accordingly, the proportion of the semiconductor fine particles is preferably 10% by mass or more and 40% by mass or less in relation to the total weight of the whole suspension.

As the semiconductor fine particles, it is possible to use, for example, the particles of a single semiconductor compound or two or more semiconductor compounds, having an appropriate average particle size of, for example, about 1 nm or more and 500 nm or less. For the purpose of increasing the specific surface area, semiconductor fine particles having an average particle size of about 1 nm or more and 50 nm or less are preferable. Additionally, for the purpose of enhancing the utilization rate of the incident light, semiconductor particles having a relatively larger average particle size of about 200 nm or more and 400 nm or less may also be added.

Examples of the method for producing a semiconductor fine particle include the sol-gel method such as the hydrothermal method, the sulfuric acid method and the chlorine method; the method for producing a semiconductor fine particle is not limited as long as the method can produce the intended fine particle; however, from the viewpoint of crystallinity, it is preferable to synthesize the semiconductor fine particle by the hydrothermal method.

Examples of the dispersion medium of the suspension include: glyme solvents such as ethylene glycol monomethyl ether; alcohols such as isopropyl alcohol; mixed solvents such as a mixture of isopropyl alcohol and toluene; and water.

The application of the suspension can be performed by common application methods such as a doctor blade method, a squeeze method, a spin coating method and a screen printing method. The drying and firing conditions of the coating film after the application of the suspension can be, for example, such that the atmosphere is the air or an inert gas, the temperature range is about 50° C. or higher and 800° C. or lower and the time range is from about 10 seconds to 12 hours. The drying and firing can be performed once at a single temperature or two or more times at varied temperatures.

The other types of semiconductor layers other than the porous semiconductor layer can be formed by using the common formation method of the semiconductor layer to be used for the photoelectric conversion element.

<Dye>

As the dye in the photoelectric conversion element according to the present exemplary embodiment, the foregoing indole compound represented by the general formula (1) can be used.

Examples of the method for making the semiconductor layer 1 adsorb the dye include: a method in which the semiconductor substrate (namely, a conductive substrate provided with the semiconductor layer 1) is immersed in a solution in which the dye is dissolved, or a method in which a dye solution is applied to the semiconductor layer so as for the dye to be adsorbed to the semiconductor layer.

Examples of the solvent for the dye solution include: nitrile-based solvents such as acetonitrile, propionitrile and methoxyacetonitrile; alcohol-based solvents such as methanol, ethanol and isopropyl alcohol; ketone-based solvents such as acetone, methyl ethyl ketone, methyl isobutyl ketone and cyclohexanone; ester-based solvents such as ethyl acetate and butyl acetate; ether-based solvents such as tetrahydrofuran and dioxane; amide-based solvents such as N,N-dimethylformamide, N,N-dimethylacetamide and N-methyl-2-pyrrolidone; halogen-based solvents such as dichloromethane, chloroform, dichloroethane, trichloroethane and chlorobenzene; hydrocarbon solvents such as toluene, xylene and cyclohexane; and water. These solvents may be used each alone or as mixtures of two or more thereof.

When the semiconductor substrate is immersed in the dye solution, the solution may be stirred, heated and refluxed, or irradiated with an ultrasonic wave.

After the dye adsorption treatment is performed, for the purpose of removing the dye remaining unadsorbed, the semiconductor substrate is preferably washed with a solvent such as an alcohol.

The dye loading amount can be set within a range of 1×10⁻¹⁰ or more and 1×10⁻⁴ mol/cm² or less, and preferably falls within a range of 1×10⁻⁹ or more and 9.0×10⁻⁶ mol/cm² or less. Within such a range, the improvement effect of the photoelectric conversion efficiency can be obtained economically and sufficiently,

For the purpose of extending as much as possible the wavelength range capable of performing photoelectric conversion and enhancing the conversion efficiency, two or more types of dyes may be used as a mixture; in such a case, it is preferable to appropriately select the types and the proportions of the dyes in consideration of the absorption wavelength ranges and absorption intensities of the dyes.

For the purpose of suppressing the decrease of the conversion efficiency due to the mutual association of the dye molecules, an additive may be used in combination when the dye is adsorbed. Examples of such an additive include a steroid-based compound having a carboxy group (such as deoxycholic acid, cholic acid and kenodeoxycholic acid).

<Counter Electrode>

The counter electrode 8 in the photoelectric conversion element according to the present exemplary embodiment has a catalyst layer 6 on the substrate 7. In the photoelectric conversion element, the holes generated from the dye adsorbed to the semiconductor layer 1 due to the incidence of light are conveyed to the counter electrode 8 through the electrolyte layer 5; the counter electrode 8 is not limited with respect to the material thereof, as long as the counter electrode 8 performs the function such that the annihilation of the electron-hole pairs occurs efficiently.

The catalyst layer 6 of the counter electrode 8 can be formed on the substrate 7 as a metal vapor deposition film by a method such as a vapor deposition method. For example, the catalyst layer 6 may be a Pt layer formed on the substrate 7. The catalyst layer 6 of the counter electrode 8 may include a nanocarbon material. For example, the catalyst layer 6 of the counter electrode 8 may be formed by sintering a paste including carbon nanotube, carbon nanohorn or carbon fiber on a porous insulating film. The nanocarbon material has a large specific surface area, and can improve the probability of the annihilation of the electron-hole pair.

Examples of the substrate 7 include a transparent substrate made of glass or a polymer film, or a metal plate (foil). When the light transmitting counter electrode 3 is prepared, it can be prepared by selecting a glass plate having a transparent conductive film as the substrate 7, and by forming a layer made of a material such as platinum or carbon as the catalyst layer 6 on the film by using a vapor deposition method or a sputtering method.

<Electrolyte Layer>

The electrolyte layer (charge transport layer) 5 in the photoelectric conversion element according to the present exemplary embodiment has a function to transport to the counter electrode 8 the holes generated from the dye adsorbed to the semiconductor layer 1 due to the incidence of light. As such an electrolyte layer, for example, the following can be used: an electrolyte solution prepared by dissolving an oxidation-reduction pair in an organic solvent; a gel electrolyte prepared by impregnating into a polymer matrix a liquid made by dissolving an oxidation-reduction pair in an organic solvent; a molten salt containing an oxidation-reduction pair; an solid electrolyte; and an organic positive hole transport material.

The electrolyte layer can be constituted with an electrolyte, a solvent and an additive.

Examples of the electrolyte include: combinations of I₂ and an iodide including metal iodides such as LiI, NaI, KI, CsI and CaI₂, and iodine salts of the quaternary ammonium compounds such as tetraalkylammonium iodide, pyridinium iodide and imidazolium iodide; combinations of Br₂ and a bromide including metal bromides such as LiBr, NaBr, KBr, CsBr and CaBr₂, and bromine salts of quaternary ammonium compounds such as tetraalkylammonium bromide and pyridinium bromide; metal complexes such as ferrocyanic acid salt-ferricyanic acid salt and ferrocene-ferricinium ion; sulfur compounds such as sodium polysulfide and alkylthiol-alkyl disulfide; viologen dyes; and hydroquinone-quinone. Among these, the combination of LiI and pyridinium iodide or the combination of imidazolium iodide and I₂ is preferable. The foregoing electrolytes may be used each alone or as mixtures of two or more thereof. As the electrolyte, a molten salt which is in a molten state at room temperature can also be use; in such a case, no solvent may be used.

Examples of the solvent used in the electrolyte layer include: carbonate-based solvents such as ethylene carbonate, diethyl carbonate, dimethyl carbonate and propylene carbonate; amide-based solvents such as N-methyl-2-pyrrolidone and N,N-dimethylformamide; nitrile-based solvents such as methoxypropionitrile, propionitrile, methoxyacetonitrile and acetonitrile; lactone-based solvents such as γ-butyrolactone and valerolactone; ether-based solvents such as tetrahydrofuran, dioxane, diethyl ether and ethylene glycol dialkyl ether; alcohol-based solvents such as methanol, ethanol and isopropyl alcohol; aprotic polar solvents such as dimethyl sulfoxide and sulfolane; and heterocyclic compounds such as 2-methyl-3-oxazolidinone and 2-methyl-1,3-dioxolane. These solvents may be used each alone or as mixtures of two or more thereof.

For the purpose of suppressing the dark current, a basic compound may be added to the electrolyte layer. The type of the basic compound is not particularly limited; however, examples of the basic compound include t-butylpyridine, 2-picoline and 2,6-lutidine. When a basic compound is added, the addition amount of the basic compound can be, for example, about 0.05 mol/L or more and 2 mol/L or less.

As the electrolyte, a solid electrolyte can also be used. As the solid electrolyte, a gel electrolyte or a completely solid electrolyte can be used.

As the gel electrolyte, a gel electrolyte obtained by adding an electrolyte or an ordinary temperature molten salt to a gelling agent can be used. Examples of the gelation method include the techniques such as the addition of a polymer or an oil gelling agent, the polymerization of the concomitantly present multifunctional monomers, or the cross-linking reaction of a polymer.

Examples of the polymer in the case where gelation is performed by adding a polymer include polyacrylonitrile and polyvinylidene fluoride. Examples of the oil gelling agent include: dibenzylidene-D-sorbitol, cholesterol derivatives, amino acid derivatives, alkylamide derivatives of trans-(1R,2R)-1,2-cyclohexanediamine, alkylurea derivatives, N-octyl-D-gluconamide benzoate, twin type amino acid derivatives, and quaternary ammonium salt derivatives.

In the case where gelation is performed by polymerization of a multifunctional monomer, the monomers used in such a case are preferably compounds having two or more ethylenically unsaturated groups; examples of such compounds include: divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, pentaerythritol triacrylate and trimethylolpropane triacrylate. When gelation is performed, monofunctional monomers other than the multifunctional monomer may be included. Examples of the monofunctional monomer include: esters and amides derived from acrylic acid and α-alkylacrylic acid, such as acrylamide, N-isopropylacrylamide, methyl acrylate and hydroxyethyl acrylate; esters derived from maleic acid and fumaric acid such as dimethyl maleate, diethyl fumarate and dibutyl maleate; dienes such as butadiene, isoprene and cyclopentadiene; aromatic vinyl compounds such as styrene, p-chlorostyrene and sodium styrenesulfonate; vinyl esters such as vinyl acetate; nitriles such as acrylonitrile and methacrylonitrile; vinyl compounds having a nitrogen-containing heterocyclic ring such as vinylcarbazole; vinyl compounds having a quaternary ammonium salt; and additionally, N-vinylformamide, vinyl sulfonate, vinylidene fluoride, vinyl alkyl ethers, and N-phenylmaleimide. The proportion of the multifunctional monomer in relation to the total amount of the monomers is preferably 0.5% by mass or more and 70% by mass or less and more preferably 1.0% by mass or more and 50% by mass or less.

The aforementioned polymerization of the monomers for the gelation can be performed by the radical polymerization method. The radical polymerization can be performed by heating, or by using light, ultraviolet ray or electron beam, or electrochemically. Examples of the polymerization initiator used in the formation of the cross-linked polymer by heating include: azo initiators such as 2,2′-azobis(isobutyronitrile) and 2,2′-azobis(dimethylvaleronitrile); and peroxide initiators such as benzoyl peroxide. The addition amount of the polymerization initiator is preferably 0.01% by mass or more and 15% by mass or less and more preferably 0.05% by mass or more and 10% by mass or less in relation to the total amount of the monomers.

When the gelation is performed by the cross-linking reaction of a polymer, it is preferable to use in combination a polymer having a reactive group necessary for the cross-linking reaction and a cross-linking agent. Examples of the preferable crosslinking reactive group include nitrogen-containing heterocyclic rings such as a pyridine ring, an imidazole ring, a thiazole ring, an oxazole ring, a triazole ring, a morpholine ring, a piperidine ring and a piperazine ring; examples of a preferable cross-linking agent include bi- or more-functional compounds capable of performing electrophilic substitution reaction with an nitrogen atom such as alkyl halides, aralkyl halides, sulfonic acid esters, acid anhydrides, acid chlorides and isocyanates.

As a completely solid electrolyte, a mixture of an electrolyte and an ion-conductive polymer compound can be used. Examples of the ion-conductive polymer compound include polar polymer compounds such as polyethers, polyesters, polyamines and polysulfides.

In the photoelectric conversion element according to the present exemplary embodiment, as the charge transport material, an inorganic positive hole transport material such as copper iodide and copper thiocyanate can be used. The inorganic positive hole transport materials can be introduced into the interior of the electrode by a method such as a casting method, an application method, a spin coating method, a dipping method or an electroplating method.

In the photoelectric conversion element according to the present exemplary embodiment, instead of the electrolyte as the charge transport material, an organic positive hole transport material can be used. Examples of the organic positive hole transport material include: 2,2′,7,7′-tetrakis(N,N-di-p-methoxyphenylamine)-9,9′-spirobifluorene (for example, a compound described in Adv. Mater. 2005, 17, 813); aromatic diamines such as N,N′-diphenyl-N,N′-bis(3-methylphenyl)-(1,1′-biphenyl)-4,4′-diamine (for example, a compound described in U.S. Pat. No. 4,764,625); triphenylamine derivatives (for example, a compound described in JP04-129271A); stilbene derivatives (for example, a compound described in JP02-51162A); 30 hydrazone derivatives (for example, a compound described in JP02-226160A). The organic positive hole transport material can be introduced into the interior of the electrode by a method such as a vacuum vapor deposition method, a casting method, a spin coating method, a dipping method or an electrolysis polymerization method.

The preparation of the electrolyte layer 5 of the photoelectric conversion element of the present exemplary embodiment can be performed by the following two methods. In one method, first the counter electrode 8 is laminated on the semiconductor layer 1 to which a dye is adsorbed, and then a liquid electrolyte layer 5 is introduced into the gap between the counter electrode 8 and the semiconductor layer 1. In the other method, the electrolyte layer 5 is directly formed on the semiconductor layer 1. In the latter case, the counter electrode 8 is formed, after the formation of the electrolyte layer 5, on the electrolyte layer 5.

By using the photoelectric conversion element described above, a photoelectrochemical cell can be provided. The photoelectrochemical cell can be suitably used as a solar cell.

### EXAMPLES

Hereinafter, the present invention is described more specifically with reference to Examples.

### Example 1

### Synthesis of Indole Compound IN-1

The indole compound IN-1 was synthesized according to the following reaction formula as follows.

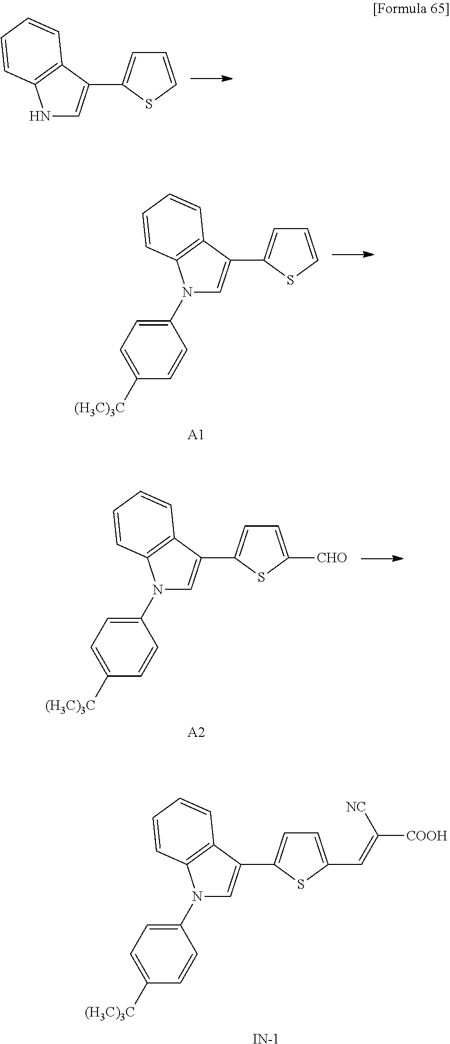

In 30 ml of toluene, 5 g of 3-(thiophen-2-yl)indole (synthesized according to the method described in JP2009-120589A) and 6.42 g of p-bromo-t-butylbenzene were dissolved, to the resulting solution 0.239 g of copper iodide, 0.442 g of N,N′-dimethylethylenediamine and 11.18 g of tripotassium phosphate were added, and the resulting mixture was allowed to react in argon atmosphere at 110° C. for 24 hours. To the reaction mixture, after being allowed to cool, 200 ml of ethyl acetate was added and the reaction mixture was washed with water. Then, the reaction mixture was dried with magnesium sulfate, and then the solvent was distilled off under reduced pressure. The resulting residue was separated and purified with silica gel column (developing solvent: a hexane/ethyl acetate (volume mixing ratio: 10/1) mixed solvent) to yield 6.78 g (yield: 82%) of the compound A1.

Next, 2 g of the compound A1 was dissolved in 20 ml of N,N-dimethylformamide, and to the resulting solution, 1.388 g of phosphorus oxychloride was dropwise added while the solution was being cooled over ice. The resulting reaction solution was stirred overnight at room temperature, and 200 ml of a 10% by mass aqueous solution of sodium acetate was added to the reaction solution and the organic layer was extracted with 200 ml of diethyl ether. Next, the resulting extract was washed with water, then dried with magnesium sulfate, and the solvent was distilled off under reduced pressure. The resulting residue was separated and purified with silica gel column (developing solvent: a hexane/ethyl acetate (volume mixing ratio: 5/1) mixed solvent) to yield 0.737 g (yield: 35%) of the compound A2.

Next, 0.7 g of the compound A2 and 0.248 g of cyanoacetic acid were dissolved in 20 ml of acetonitrile, 0.332 g of piperidine was added to the resulting solution, and the solution was heated and refluxed for 3 hours. The solution was allowed to cool, and then poured into 500 ml of iced water containing 0.5 ml of hydrochloric acid; then the precipitated crystal was filtered off and washed with water. The filtered crystal was dispersed in a hexane/ethyl acetate (volume mixing ratio: 3/1) mixed solvent, and washed by heating and stirring to yield 0.356 g (yield: 43%) of the targeted indole compound IN-1.

The measurement results of the ¹H-NMR (dichloromethane-d₂) of the obtained indole compound IN-1 were as follows, in terms of δ: 8.34 (1H, s), 8.09-8.10 (2H, m), 7.87 (1H, d), 7.64 (2H, d), 7.55-7.60 (4H, m), 7.27-7.30 (2H, m), 4.39 (2H, s), 1.40 (9H, s).

FIG. 2 shows the absorption spectrum curve of the obtained indole compound IN-1 (dye) in acetonitrile. The λmax of the indole compound IN-1 was found to be 449 nm.

### Example 2

### Synthesis of Indole Compound IN-2

The indole compound IN-2 was synthesized according to the following reaction formula as follows.

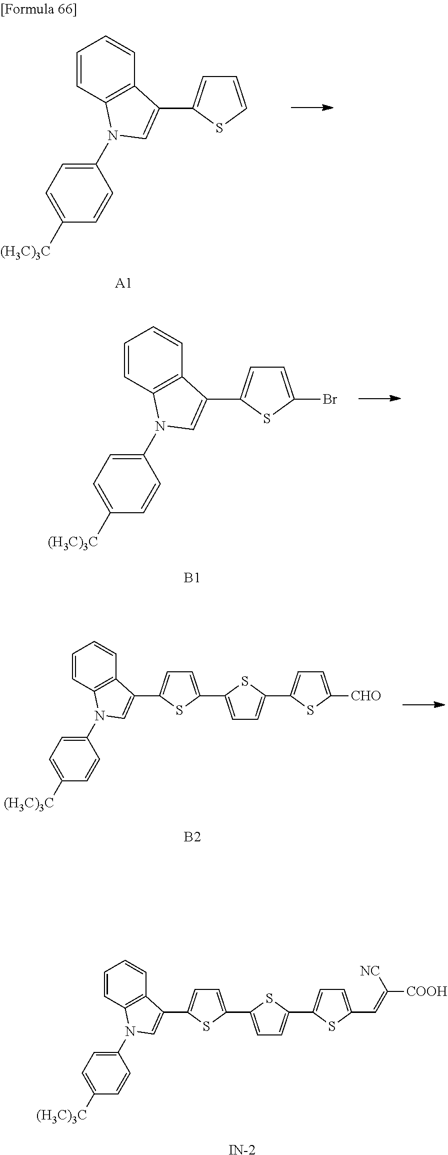

In 90 ml of tetrahydrofuran, 2.78 g of the compound A1 synthesized in the same manner as in Example 1 was dissolved, and to the resulting solution, 1.493 g of N-bromosuccinimide (NBS) was added at −78° C. and stirred for 3 hours. The reaction solution was allowed to get back to room temperature, and 200 ml of a 3% by mass aqueous solution of sodium carbonate was added to the solution and the organic layer was extracted with 300 ml of diethyl ether. Next, the extract was washed with water and then dried with magnesium sulfate, and the solvent was distilled off under reduced pressure. The resulting residue was stirred in 15 ml of hot methanol, allowed to cool and then filtered to yield 2.3 g (yield: 67%) of the compound B1.

Next, 2 g of the compound B1 was dissolved in 40 ml of dried tetrahydrofuran, and to the resulting solution, 4.6 ml of a 1.6 mol/L hexane solution of n-butyllithium was dropwise added in argon atmosphere at −78° C. The resulting solution was stirred for 30 minutes, and then 0.731 g of zinc chloride was added to the solution and stirred at −78° C. for 30 minutes and at room temperature for 1 hour. To the resulting mixture, 0.666 g of 5-bromo-2,2′-bithiophene-5′-carooxyaldehyde and 0.169 g of tetrakis(triphenylphosphine)palladium were added and stirred at room temperature for 3 hours. To the reaction mixture, 200 ml of ethyl acetate was added, and washed with a 3% by mass aqueous solution of sodium carbonate and an aqueous solution of NaCl in this order. Next, the reaction mixture was dried with magnesium sulfate, and the solvent was distilled off under reduced pressure. The resulting residue was separated and purified with silica gel column (developing solvent: a hexane/ethyl acetate (volume mixing ratio: 2/1) mixed solvent) to yield 0.348 g (yield: 27%) of the compound B2.

Next, 0.2 g of the compound B2 and 0.049 g of cyanoacetic acid were dissolved in 20 ml of chloroform, 0.065 g of piperidine was added to the resulting solution, and the solution was heated and refluxed for 6 hours. The solution was allowed to cool and then concentrated under reduced pressure; the concentrated product was dissolved in a small amount of tetrahydrofuran, and the resulting solution was dropwise added to 500 ml of iced water containing 0.5 ml of hydrochloric acid; then the precipitated crystal was filtered off and washed with water. The filtered crystal was dispersed in a hexane/ethyl acetate (volume mixing ratio: 3/1) mixed solvent, and washed by heating and stirring to yield 0.111 g (yield: 49%) of the targeted indole compound IN-2.

The measurement results of the ¹H-NMR (tetrahydrofuran-d₈) of the obtained indole compound IN-2 were as follows, in terms of δ: 8.40 (1H, s), 8.08-8.12 (1H, m), 7.89 (1H, s), 7.86 (1H, d), 7.68 (2H, d), 7.58-7.63 (3H, m), 7.54 (1H, d), 7.46 (1H, d), 7.4-7.42 (2H, m), 7.33 (1H, d), 7.28-7.30 (2H, m), 1.46 (9H, s).

FIG. 3 shows the absorption spectrum curve of the obtained indole compound IN-2 (dye) in acetonitrile. The λmax of the indole compound IN-2 was found to be 498 nm.

### Example 3

### Synthesis of Indole Compound IN-3

The indole compound IN-3 was synthesized according to the following reaction formula as follows.

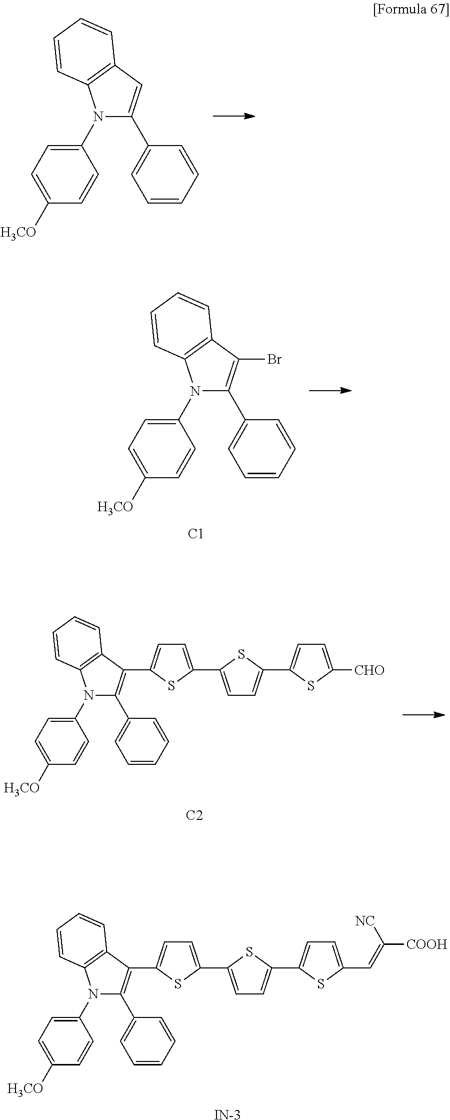

In 130 ml of tetrahydrofuran, 3.9 g of 1-(4-methoxyphenyl)-2-phenylindole (synthesized according to the method described in J. Am. Chem. Soc., 2002, Vol. 124, pp. 11684 to 11688) was dissolved, and to the resulting solution, 2.366 g of N-bromosuccinimide (NBS) was added at −78° C. and stirred for 1 hour. Then, the reaction solution was allowed to get back to room temperature, and 200 ml of a 3% by mass aqueous solution of sodium carbonate was added to the solution and the organic layer was extracted with 300 ml of diethyl ether. Next, the extract was washed with an aqueous solution of NaCl and then dried with magnesium sulfate, and the solvent was distilled off under reduced pressure. The resulting residue was recrystallized with a hexane/ethyl acetate (volume mixing ratio=1/1) mixed solvent to yield 3.29 g (yield: 67%) of the compound C1.

Next, 3 g of the compound C1 was dissolved in 60 ml of dried tetrahydrofuran, and to the resulting solution, 7.5 ml of a 1.6 mol/L hexane solution of n-butyllithium was dropwise added in argon atmosphere at −78° C. The resulting solution was stirred for 30 minutes, and then 1.19 g of zinc chloride was added to the solution and stirred at −78° C. for 30 minutes and at room temperature for 1 hour. To the resulting mixture, 1.41 g of 5″-bromo-2,2′:5′,2″-terthiophene-5-carboxaldehyde and 0.275 g of tetrakis(triphenylphosphine)palladium were added and stirred at room temperature for 3 hours. To the reaction mixture, 200 ml of ethyl acetate was added, and washed with a 3% by mass aqueous solution of sodium carbonate and an aqueous solution of NaCl in this order. Next, the reaction mixture was dried with magnesium sulfate, and then the solvent was distilled off under reduced pressure. The resulting residue was separated and purified with silica gel column (developing solvent: a hexane/ethyl acetate (volume mixing ratio: 2/1) mixed solvent) to yield 0.6 g (yield: 26%) of the compound C2.

Next, 0.25 g of the compound C2 and 0.056 g of cyanoacetic acid were dissolved in 20 ml of chloroform, 0.093 g of piperidine was added to the resulting solution, and the solution was heated and refluxed for 8 hours. The solution was allowed to cool, then 200 ml of chloroform was added to the solution, and the solution was washed with diluted hydrochloric acid, and further washed with water. Next, the solution was dried with magnesium sulfate, and then the solvent was distilled off under reduced pressure. The resulting residue was dissolved in a small amount of tetrahydrofuran, and the resulting solution was subjected to reprecipitation in a hexane/ethyl acetate (volume mixing ratio: 10/1) mixed solvent to yield 0.189 g (yield: 68%) of the targeted indole compound IN-3.

The measurement results of the ¹H-NMR (tetrahydrofuran-d₈) of the obtained indole compound IN-3 were as follows, in terms of δ: 8.33 (1H, s), 7.96 (1H, d), 7.79 (1H, d), 7.43 (1H, d), 7.38 (1H, d), 7.26-7.29 (5H, m), 7.16-7.21 (7H, m), 6.92 (2H, d), 6.87 (1H, d), 3.78 (3H, s).

The λmax of the obtained indole compound IN-3 (dye) in chloroform was found to be 497 nm.

### Example 4

### Synthesis of Indole Compound IN-4

The indole compound IN-4 was synthesized according to the following reaction formula as follows.

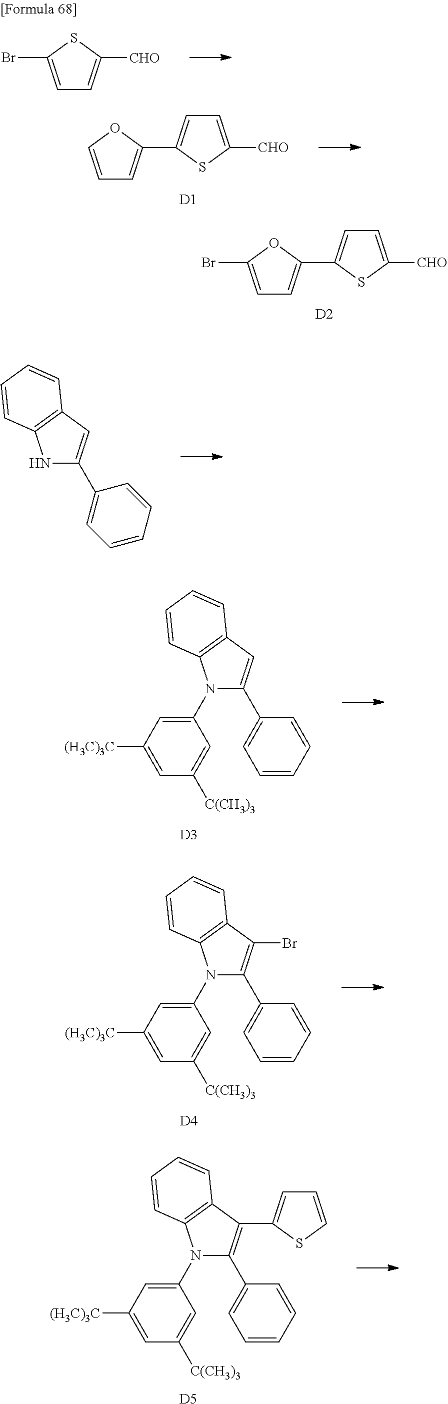

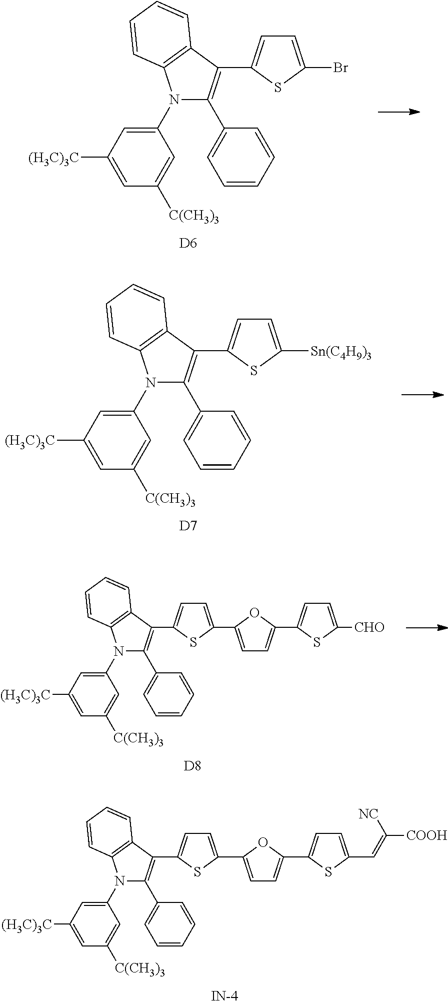

In 55 ml of 1,4-dioxane, 5 g of 5-bromothiophene-2-carboxaldehyde and 9.82 g of 2-(tributylstannyl)furan were dissolved, and to the resulting solution, 0.275 g of tetrakis(triphenylphosphine)palladium was added and stirred at 90° C. for 5 hours. The resulting mixture was cooled to room temperature, the solvent was distilled off, and the resulting residue was separated and purified with silica gel column (developing solvent: a hexane/ethyl acetate (volume mixing ratio: 20/1) mixed solvent) to yield 4.42 g of the compound D1.

Next, 3.64 g of D1 was dissolved in 160 ml of dichloromethane, and to the resulting solution, 3.99 g of NBS was added at −20° C. and stirred for 4 hours. The solvent was distilled off under reduced pressure, and the resulting residue was separated and purified with silica gel column (developing solvent: a hexane/ethyl acetate (volume mixing ratio: 5/1) mixed solvent) to yield 4.79 g of the compound D2.

In 26 ml of toluene, 5 g of 2-phenylindole and 8.39 g of 3,5-di-t-butylbromobenzene were dissolved, and to the resulting solution 11.5 g of K₃PO₄, 0.249 g of copper(I) iodide and 0.55 ml of N,N′-dimethylethylenediamine were added, and the resulting mixture was heated and refluxed for 72 hours. The mixture was cooled to room temperature, then 600 ml of ethyl acetate was added to the mixture, and the mixture was filtered. The filtrate was subjected to distillation under reduced pressure, and the resulting residue was separated and purified with silica gel column (developing solvent: a hexane/chloroform (volume mixing ratio: 9/1) mixed solvent to yield 9.4 g of the compound D3.

Next, 9 g of D3 was dissolved in 260 ml of THF, and to the resulting solution, 4.2 g of NBS was added at 0° C. and stirred for 1 hour. The solvent was distilled off under reduced pressure, and the resulting residue was washed with water (100 ml×2), a saturated aqueous solution of sodium hydrogen carbonate (100 ml×2), water (100 ml×2) and methanol (50 ml×2) to yield 9 g of D4.

Next, 7.66 g of D4 and 7.45 g of 2-(tributylstannyl)thiophene were dissolved in 330 ml of DMF, and to the resulting solution, 0.922 g of tetrakis(triphenylphosphine)palladium was added and stirred at 100° C. for 6 hours. The resulting mixture was cooled to room temperature, the solvent was distilled off under reduced pressure, and the resulting residue was separated and purified with silica gel column (developing solvent: a hexane/chloroform (volume mixing ratio: 1/5) mixed solvent) to yield 8 g of the compound D5.

Next, 4.8 g of D5 was dissolved in 100 ml of THF, and to the resulting solution, 1.83 g of NBS was added at 0° C. and stirred for 1 hour. Then, the solvent was distilled off under reduced pressure, and the resulting residue was washed with water (100 ml×2), a saturated aqueous solution of sodium hydrogen carbonate (100 ml×2), water (100 ml×2) and methanol (50 ml×2) to yield 5.2 g of D6.

Next, 5 g of D6 was dissolved in 80 ml of THF, and to the resulting solution, 3.84 ml of a hexane solution of n-butyllithium (2.64 M) was dropwise added at −78° C. and stirred for 1 hour. To the resulting mixture, 3.99 g of tributyltin chloride was added, and the mixture was further stirred for 1 hour, and allowed to get back to room temperature. Water was added to the mixture and the organic layer was extracted with diethyl ether, the organic layer was dried with magnesium sulfate, and then the solvent was distilled off under reduced pressure to yield 8 g of the compound D7.

Next, 2 g of D2 and 8 g of D7 were dissolved in 80 ml of dioxane, and to the resulting solution, 0.223 g of tetrakis(triphenylphosphine)palladium was added and stirred at 100° C. for 5 hours. The resulting mixture was cooled to room temperature, then the solvent was distilled off under reduced pressure, and the resulting residue was separated and purified with silica gel column (developing solvent: a hexane/toluene (volume mixing ratio: 1/4) mixed solvent) to yield 3.8 g of the compound D8.

Next, 2 g of D8 and 0.399 g of cyanoacetic acid were dissolved in 60 ml of chloroform, 0.665 g of piperidine was added to the resulting solution, and the solution was heated and refluxed for 8 hours. The solution was allowed to cool, then 200 ml of chloroform was added to the solution, and the solution was washed with diluted hydrochloric acid, and further washed with water. Next, the solution was dried with magnesium sulfate, and then the solvent was distilled off under reduced pressure. The resulting residue was dissolved in a small amount of tetrahydrofuran, and the resulting solution was subjected to reprecipitation in hexane to yield 1.171 g (yield: 53%) of the targeted indole compound IN-4.

The measurement results of the ¹H-NMR (tetrahydrofuran-d₈) of the obtained indole compound IN-4 were as follows, in terms of δ: 8.33 (1H, s), 7.96 (1H, d), 7.79 (1H, d), 7.43 (1H, d), 7.38 (1H, d), 7.26-7.29 (5H, m), 7.16-7.21 (7H, m), 6.92 (2H, d), 6.87 (1H, d), 3.78 (3H, s).

The λmax of the obtained indole compound IN-4 (dye) in THF was found to be 484 nm.

### Example 5

### Synthesis of Indole Compound IN-5

The indole compound IN-5 was synthesized according to the following reaction formula as follows.

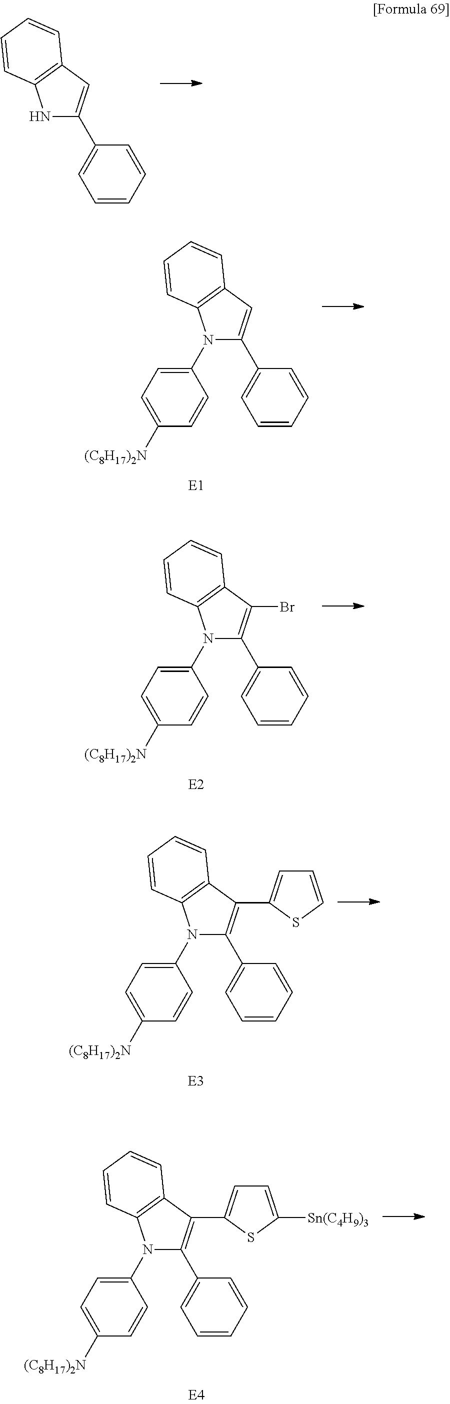

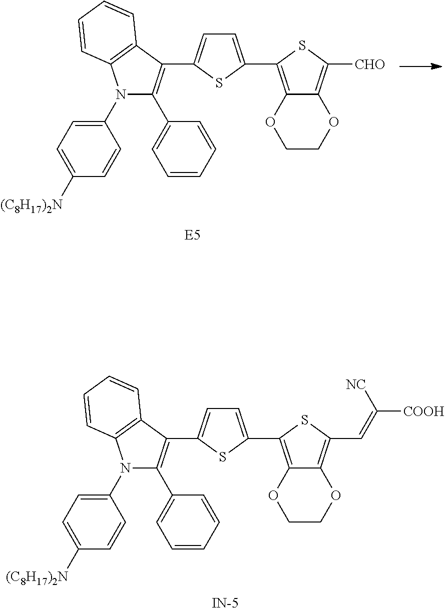

In 40 ml of toluene, 8.12 g of 2-phenylindole and 20 g of 4-bromo-N,N-dioctylaniline were dissolved, and to the resulting solution, 18.72 g of K₃PO₄, 0.8 g of copper(I) iodide and 1.82 ml of N,N′-dimethylethylenediamine were added; the resulting mixture was heated and refluxed for 3 days. The mixture was cooled to room temperature, 600 ml of ethyl acetate was added to the mixture, and the resulting mixture was filtered. The filtrate was subjected to distillation under reduced pressure, and the resulting residue was separated and purified with silica gel column (developing solvent: a hexane/chloroform (volume mixing ratio: 20/1) mixed solvent to yield 15 g of the compound E1.

Next, 13.3 g of E1 was dissolved in 250 ml of THF, and to the resulting solution, 4.67 g of NBS was added at 0° C. and stirred for 3 hours. The solvent was distilled off under reduced pressure, 50 ml of hexane was added to the resulting residue, and then the precipitated crystal was filtered off to yield 13 g of E2.

Next, 10.7 g of E2 and 8.14 g of 2-(tributylstannyl)thiophene were dissolved in 300 ml of dioxane, and to the resulting solution, 0.987 g of tetrakis(triphenylphosphine)palladium was added and stirred at 100° C. for 2 days. The resulting mixture was cooled to room temperature, the solvent was distilled off under reduced pressure, and the resulting residue was separated and purified with silica gel column (developing solvent: a hexane/chloroform (volume mixing ratio: 1/5) mixed solvent) to yield 6 g of the compound E3.

Next, 10 g of E3 was dissolved in 150 ml of dried THF, and to the resulting solution, 12.7 ml of a hexane solution (1.6 M) of n-butyllithium was dropwise added at −78° C. and stirred for 2 hours. To the resulting solution, 7.16 g of tributyltin chloride was added, the solution was further stirred overnight at room temperature. Water was added to the resulting mixture, and the organic layer was extracted with diethyl ether, the organic layer was dried with magnesium sulfate, and then the solvent was distilled off under reduced pressure to yield 13.4 g of the compound E4.

Next, 6.889 g of E4 and 1.5 g of 2-bromothiophene-5-carboxaldehyde were dissolved in 50 ml of 1,4-dioxane, and to the resulting solution, 0.209 g of tetrakis(triphenylphosphine)palladium was added and stirred at 100° C. for 12 hours. The resulting mixture was cooled to room temperature, the solvent was distilled off under reduced pressure, and the resulting residue was separated and purified with silica gel column (developing solvent: a chloroform/toluene (volume mixing ratio: 1/1) mixed solvent) to yield 3.4 g of the compound E5.

Next, 0.5 g of E5 and 0.084 g of cyanoacetic acid were dissolved in 30 ml of chloroform, 0.14 g of piperidine was added to the resulting solution, and the solution was heated and refluxed for 8 hours. The solution was allowed to cool, then 200 ml of chloroform was added to the solution, and the solution was washed with diluted hydrochloric acid, and further washed with water. Next, the solution was dried with magnesium sulfate, and then the solvent was distilled off under reduced pressure. The resulting residue was dissolved in a small amount of tetrahydrofuran, and the resulting solution was subjected to reprecipitation in a hexane to yield 0.305 g (yield: 56%) of the targeted indole compound IN-5.

The measurement results of the ¹H-NMR (chloroform-d) of the obtained indole compound IN-5 were as follows, in terms of δ: 8.32 (1H, s), 8.00 (1H, d), 7.32 (1H, d), 7.2-7.25 (8H, m), 6.97 (2H, d), 6.75 (1H, d), 6.52 (2H, d), 4.33 (2H, brs), 4.24 (2H, brs), 3.22 (4H, t), 1.55 (4H, br), 1.2-1.36 (20H, br), 0.88 (6H, t).

The λmax of the obtained indole compound IN-5 (dye) in THF was found to be 493 nm.

### Example 6

### Preparation of Photoelectric Conversion Element

A photoelectric conversion element was prepared as follows.

(a) Preparation of Semiconductor Electrode and Counter Electrode

First, a semiconductor electrode was prepared in the following sequence.

A FTO coated glass plate (10 Ωcm²) having a size of 15 mm×15 mm and a thickness of 1.1 mm was prepared as a conductive substrate (a light-transmitting substrate having a transparent conductive layer).

A titanium oxide paste (a material of the semiconductor layer) was prepared as follows.

A mixture was prepared by mixing 5 g of a commercially available titanium oxide powder (trade name: P25, manufactured by Japan Aerosil Co., Ltd., average primary particle size: 21 nm), 20 ml of a 15 vol % aqueous solution of acetic acid, 0.1 ml of a surfactant (trade name: Triton (registered trademark) X-100, manufactured by Sigma-Aldrich, Inc.), and 0.3 g of polyethylene glycol(molecular weight: 20000) (product code: 168-11285, manufactured by Wako Pure Chemical Industries, Ltd.); the resulting mixture was stirred with a stirring mixer for about 1 hour to yield a titanium oxide paste.

Next, the titanium oxide paste was applied (applied area: 10 mm×10 mm) to the FTO coated glass plate by a doctor blade method so as for the film thickness of the paste layer to be about 50 μm.

Then, the FTO coated glass plate applied with the titanium oxide paste was placed in an electric furnace, fired in the atmosphere at 450° C. for about 30 minutes, and then allowed to be spontaneously cooled to yield a porous titanium oxide film on the FTO coated glass plate.

Further, on the titanium oxide film, a light scattering layer was formed as follows. A titanium oxide paste (trade name: PST-400C, manufactured by JGC Catalysts and Chemicals Ltd.) having an average particle size of 400 nm was applied to the aforementioned titanium oxide film in a thickness of 20 μm by a screen printing method. Then, the thus treated glass plate was fired in the atmosphere at 450° C. for about 30 minutes, and allowed to be spontaneously cooled to yield a light scattering layer on the titanium oxide film.

As described above, the semiconductor electrode before the adsorption of a dye was obtained.

On the other hand, a counter electrode was prepared as follows. On a soda-lime glass plate (thickness: 1.1 mm), a platinum layer was vapor-deposited as a catalyst layer by a vacuum vapor deposition method in an average thickness of 1 μm, and thus the counter electrode was obtained.

(b) Adsorption of Dye

Next, a dye was adsorbed to the semiconductor layer composed of the titanium oxide film and the light scattering layer. For the adsorption of a dye, a solution prepared by dissolving the indole compound IN-1 of Example 1 in acetonitrile in a concentration of 0.2 mM and by further adding deoxycholic acid as a co-adsorbent in a concentration of 150 mM was used. The aforementioned semiconductor electrode was immersed into the dye solution for 6 hours. Then, the semiconductor electrode was taken out from the dye solution, rinsed with acetonitrile to remove the superfluous dye, and dried in the air to yield a dye-adsorbed semiconductor electrode.

(c) Cell Assembly

The semiconductor electrode subjected to the dye adsorption treatment and the counter electrode were disposed so that the semiconductor layer and the catalyst layer face each other, to form the cell before the injection of the electrolyte. Next, a thermosetting resin film having slits large enough to allow the electrolyte to be impregnated into the gap between the semiconductor electrode and the counter electrode was thermocompression bonded to the periphery of the cell.

(d) Injection of Electrolyte

An iodine-based electrolyte was injected into the cell through the slits so as to be impregnated into between the semiconductor electrode and the counter electrode. The iodine-based electrolyte used was a solution in which acetonitrile was used as a solvent, the concentration of iodine was 0.5 mol/L, the concentration of lithium iodide was 0.1 mol/L, the concentration of 4-tert-butylpyridine was 0.5 mol/L and the concentration of 1,2-dimethyl-3-propylimidazolium iodide was 0.6 mol/L.

(e) Measurement of Photocurrent

The photoelectric conversion element prepared as described above was irradiated with light having an intensity of 100 mW/cm² under the condition of AM 1.5 by using a solar simulator, and the generated electricity was measured with a current/voltage measurement apparatus to evaluate the photoelectric conversion property. Consequently, a photoelectric conversion efficiency of 3.6% was obtained.

### Examples 7 and 8

Photoelectric conversion elements were prepared in the same manner as in Example 6 except that in place of the indole-based dye IN-1, the indole-based dye IN-2 or IN-3 was used. The photoelectric conversion property of each of the obtained photoelectric conversion elements was evaluated; consequently, the element using IN-2 (Example 7) gave a photoelectric conversion efficiency of 4.3% and the element using IN-3 (Example 8) gave a photoelectric conversion efficiency of 4.5%.

### Example 9

A photoelectric conversion element was prepared in the same manner as in Example 4 except that the dye solution was altered. The dye solution used was a 0.3 mM ethanol solution of IN-4 to which deoxycholic acid was added as a co-adsorbent in a concentration of 160 mM.

The photoelectric conversion property of the obtained photoelectric conversion element was evaluated; consequently, the element using IN-4 gave a photoelectric conversion efficiency of 5.0%.

### Example 10

A photoelectric conversion element was prepared in the same manner as in Example 9 except that the dye solution was altered. The dye solution used was a 0.1 mM solution of IN-5 dissolved in a THF/acetonitrile/t-butanol (2/4/4) mixed solvent to which deoxycholic acid was added as a co-adsorbent in a concentration of 1 mM. The photoelectric conversion property of the obtained photoelectric conversion element was evaluated; consequently, the element using IN-5 gave a photoelectric conversion efficiency of 5.2%.

As is obvious from the above-presented description, the use of the indole compounds according to the exemplary embodiment of the present invention as the photoelectric conversion dye enables to obtain photoelectric conversion elements excellent in photoelectric conversion efficiency and semiconductor electrodes to be used in the photoelectric conversion elements. Such a photoelectric conversion element can be applied to a photoelectrochemical cell, and is particularly suitable for a solar cell. Such a photoelectric conversion element can also achieve the cost reduction as compared to the case where a metal complex including a noble metal is used.

The present invention has been described above with reference to the exemplary embodiments and Examples; however, the present invention is not limited to the exemplary embodiments and Examples. Various modifications that can be understood by those skilled in the art may be made to the constitution and the details of the present invention, within the scope of the present invention.

The present application claims the right of priority based on Japanese Patent Application No. 2010-249744 filed on Nov. 8, 2010 and Japanese Patent Application No. 2011-207708 filed on Sep. 22, 2011, the entire disclosure of which is incorporated herein by reference.

### REFERENCE SIGNS LIST

1 Semiconductor layer
2 Transparent conductive layer
3 Light-transmitting substrate
4 Semiconductor electrode
5 Electrolyte layer (charge transport layer)
6 Catalyst layer
7 Substrate
8 Counter electrode

1. An indole compound represented by the following general formula (1): 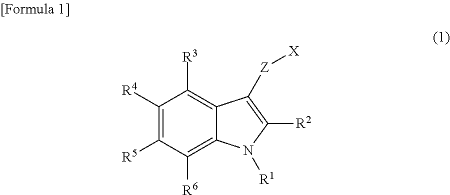
wherein in formula (1), R¹ and R² each independently represent a hydrogen atom, a substituted or unsubstituted alkyl group, a substituted or unsubstituted aryl group or a substituted or unsubstituted heterocyclic group; R³ to R⁶ each independently represent a hydrogen atom, a substituted or unsubstituted alkyl group, a substituted or unsubstituted aryl group, an alkoxy group or a hydroxy group; X represents an organic group having an acidic group; and Z represents a linking group including at least one selected from the group consisting of a substituted or unsubstituted aromatic ring, a substituted or unsubstituted heterocyclic ring, a vinylene group (—CH═CH—) and an ethynylene group (—C≡C—); and wherein in the case where the structure represented by formula (1) involves a tautomer or a stereoisomer, such an isomer is also included in formula (1).

2. The indole compound according to claim 1, wherein the organic group X comprises a structure represented by the following general formula (2): 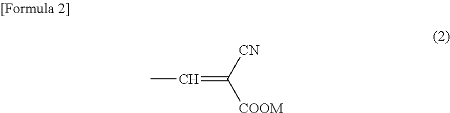
wherein in formula (2), M represents a hydrogen atom or a salt-forming cation.

3. The indole compound according to claim 1, wherein the linking group Z comprises a structure represented by the following general formula (3): 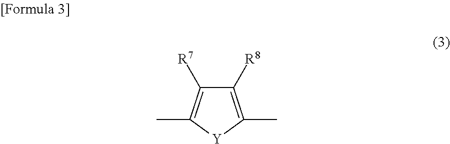
wherein in formula (3), R⁷ and R⁸ each independently represent a hydrogen atom, a substituted or unsubstituted alkyl group, or a substituted or unsubstituted alkoxy group and R⁷ and R⁸ may be linked to each other to form a ring; Y represents an oxygen atom, a sulfur atom or NRa, and Ra represents a hydrogen atom, a substituted or unsubstituted alkyl group or a substituted or unsubstituted aryl group.

4. The indole compound according to claim 1, wherein the linking group Z and the indole ring bonded to the linking group Z form a conjugated structure, and the linking group Z and the organic group X form a conjugated structure.

5. A photoelectric conversion dye comprising the indole compound according to claim 1.

6. A semiconductor electrode comprising a semiconductor layer including the photoelectric conversion dye according to claim 5.

7. The semiconductor electrode according to claim 6, wherein the semiconductor layer comprises titanium oxide or zinc oxide.

8. A photoelectric conversion element comprising the semiconductor electrode according to claim 6.

9. The photoelectric conversion element according to claim 8, further comprising:
a counter electrode facing the semiconductor electrode; and
a charge transport material disposed between the semiconductor electrode and the counter electrode.

10. A photoelectrochemical cell comprising the photoelectric conversion element according to claim 8.
